(19) United States
(12) Patent Application Publication
(10) Pub. No.: US 2025/0179252 A1
(43) Pub. Date: Jun. 5, 2025

(54) METHOD FOR PREPARING A POLYMER HAVING ESTER FUNCTIONALITY AND SAID POLYMER PREPARED THEREFROM

(71) Applicant: Agency for Science, Technology and Research, Singapore (SG)

(72) Inventors: Praveen THONIYOT, Singapore (SG); Srinivasa Reddy MOTHE, Singapore (SG); Wenguang ZHAO, Singapore (SG)

(73) Assignee: Agency for Science, Technology and Research, Singapore (SG)

(21) Appl. No.: 18/705,327

(22) PCT Filed: Oct. 27, 2022
(86) PCT No.: PCT/SG2022/050773

§ 371 Date: Apr. 26, 2024

(30) Foreign Application Priority Data
Nov. 1, 2021 (SG) 10202112154T

(51) Int. Cl. C08G 81/02

(52) U.S. Cl. CPC C08G 81/027

(57) ABSTRACT

There is provided a method for preparing a polymer having ester functionality in the backbone of the polymer, the method comprising a step of reacting a mixture of monomers that comprises: (i) at least one first acrylate and/or methacrylate monomer; (ii) at least one cyclic ketene acetal monomer; and (iii) at least one additional monomer selected from the group consisting of a second acrylate and/or methacrylate monomer that is functionalized with hydrophilic groups, a vinylic monomer that is functionalized with hydrophilic groups, and combinations thereof in aqueous media to obtain the polymer. There is also provided a polymer having ester functionality in the backbone of the polymer obtained from said method.

### TECHNICAL FIELD

The present disclosure relates broadly to a method for preparing a polymer having ester functionality and said polymer prepared therefrom.

### BACKGROUND

A wide variety of polymers have been developed over the years for use in various applications which include personal and consumer care applications, and applications in biomedical and cosmetic fields. However, most polymers (e.g., radical polymer emulsions) prepared to date are nondegradable polymer particles. This is because non-degradability is thought as a requirement for better durability of paints, adhesives etc.

The industry perspective is changing due to sustainability concerns arising from environmentally persistent nondegradable polymer latices. This is not only important for single use polymer emulsions for cosmetics or paper films formation, but also important for lasting applications such as architectural paints and durable coatings due to the reduced life span of structures as a result of extensive redevelopment around the globe. Despite this emerging need, there are only a few methods available on preparing degradable polymers.

However, there are several drawbacks of currently available methods. Firstly, these methods require working with harsh reaction conditions such as carrying out polymerization at high temperatures. Next, these methods are highly moisture-sensitive and require working in water-free environments in order to prevent undesired reactions with water. Often, these currently available polymerization methods for preparation of degradable polymers require complex experimental methods, energy intensive processes and/or multiple steps which can adversely affect scalability and sustainability.

In view of the above, there is a need to address or at least ameliorate the above-mentioned problems. In particular, there is a need to provide a versatile, efficient and scalable technique for preparing a polymer having ester functionality.

### SUMMARY

In one aspect, there is provided a method for preparing a polymer having ester functionality in the backbone of the polymer, the method comprising a step of reacting a mixture of monomers that comprises:
(i) at least one first acrylate and/or methacrylate monomer;
(ii) at least one cyclic ketene acetal monomer; and
(iii) at least one additional monomer selected from the group consisting of a second acrylate and/or methacrylate monomer that is functionalized with hydrophilic groups, a vinylic monomer that is functionalized with hydrophilic groups, and combinations thereof
in aqueous media to obtain the polymer.

In one embodiment, the reacting step is carried out in the presence of:
(a) initiator;
(b) surfactant;
(c) base; and
(d) optionally stabilizer.

In one embodiment, the reacting step comprises maintaining the pH of the mixture at an alkaline/basic pH through a controlled addition of the base at intervals.

In one embodiment, the pH of the mixture is maintained at a pH that falls in the range of from 8.0 to 12.5.

In one embodiment, the at least one first acrylate and/or methacrylate monomer is represented by general formula (1):

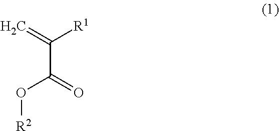

wherein
R¹ is selected from H or CH₃; and
R² is selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof.

In one embodiment, the at least one first acrylate and/or methacrylate monomer is selected from the group consisting of methyl acrylate, ethyl acrylate, n-propyl acrylate, isopropyl acrylate, n-butyl acrylate, t-butyl acrylate, isobutyl acrylate, pentyl acrylate, hexyl acrylate, n-amyl acrylate, isoamyl acrylate, heptyl acrylate, octyl acrylate, isooctyl acrylate, ethylhexyl acrylate, 2-ethylhexyl acrylate, vinyl acrylate, cycloalkyl acrylates, methyl methacrylate, ethyl methacrylate, n-propyl methacrylate, isopropyl methacrylate, n-butyl methacrylate, t-butyl methacrylate, isobutyl methaacrylate, pentyl methacrylate, hexyl methacrylate, n-amyl methacrylate, isoamyl methacrylate, heptyl methacrylate, octyl methacrylate, isooctyl methacrylate, ethylhexyl methacrylate, 2-ethylhexyl methacrylate, vinyl methacrylate, cycloalkyl methacrylates and combinations thereof.

In one embodiment, the at least one cyclic ketene acetal monomer is represented by general formula (2):

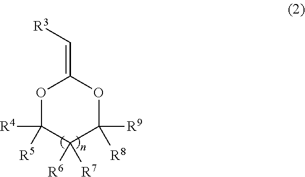

wherein
n is 0, 1, 2 or 3;
R³ is selected from H or optionally substituted linear or branched C₁-C₂₀ alkyl; and R⁴ to R⁹ are each independently selected from H, optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof.

In one embodiment, the at least one cyclic ketene acetal monomer is selected from the group consisting of 2-methylene-1,3-dioxepane (MDO), 2-methylene-1,3-dioxocane and combinations thereof.

In one embodiment, the second acrylate and/or methacrylate monomer that is functionalized with hydrophilic groups is represented by general formula (3):

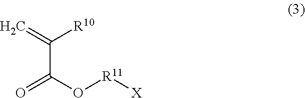

wherein
R¹⁰ is selected from H or CH₃;
R¹¹ is selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof; and
X comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof.

In one embodiment, the second acrylate and/or methacrylate monomer is selected from the group consisting of 2-hydroxyethyl acrylate (HEA), hydroxyethyl methacrylate (HEMA), 2-(dimethylamino)ethyl acrylate (DMAEA), 2-(dimethylamino)ethyl methacrylate (DMAEMA) and combinations thereof.

In one embodiment, the vinylic monomer that is functionalized with hydrophilic groups is selected from the group consisting of vinyl pyrrolidone, sodium 1-allyloxy-2-hydroxypropyl sulfonate and combinations thereof.

In one embodiment, the at least one first acrylate and/or methacrylate monomer; the at least one cyclic ketene acetal monomer; and the at least one additional monomer are mixed in a mass ratio of 10-20:2-6:0.01-2.

In one embodiment, the reacting step is carried out in the presence of a crosslinking agent at a concentration falling in the range of from 0.1 wt % to 5.0 wt % with respect to the total weight of the monomers.

In one embodiment, the initiator comprises water-soluble compound/salt optionally selected from persulfate salts, azo compounds or mixtures thereof.

In one embodiment, the surfactant comprises non-ionic surfactant optionally having one or more fatty acid ester chain and/or one or more poly(ethylene glycol)/polyoxyethylene chain.

In one embodiment, the base comprises an inorganic base optionally selected from sodium hydroxide (NaOH), potassium hydroxide (KOH), sodium carbonate (Na₂CO₃), potassium carbonate (K₂CO₃), sodium bicarbonate (NaHCO₃), potassium bicarbonate (KHCO₃), ammonium hydroxide (NH₄OH) or mixtures thereof.

In one embodiment, the reacting step comprises incorporating at least 3 mol % of the at least one cyclic ketene acetal monomer in the polymer.

In one embodiment, the reacting step is carried out at temperature of no more than 100° C.

In one aspect, there is provided a polymer having ester functionality in the backbone of the polymer, the polymer comprising one or more repeating/structural units represented general formula (4), one or more repeating/structural units represented by general formula (5) and one or more repeating/structural units represented by general formula (6) and/or general formula (8):

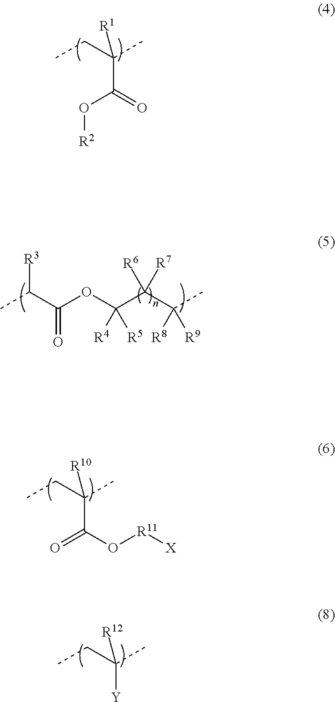

wherein
R¹ and R¹⁰ are each independently selected from H or CH₃;
R² and R¹¹ are each independently selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof;
n is 0, 1, 2 or 3;
R³ is selected from H or optionally substituted linear or branched C₁-C₂₀ alkyl;
R⁴ to R⁹ and R¹² are each independently selected from H, optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof; and
X and Y each comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof.

In one embodiment, the polymer is in the form of latex nanoparticles.

In one embodiment, the ratio of the total number of repeating/structural units represented by general formula (4), general formula (6) and/or general formula (8) to the total number of repeating/structural units represented by general formula (5) in the polymer is from 0.40 to 0.99:0.01 to 0.60.

In one embodiment, the polymer comprises at least 3 mol % of repeating units represented by general formula (5).

### Definitions

The term “polymer” as used herein refers to a chemical compound comprising repeating units and is created through a process of polymerization.

The units composing the polymer are typically derived from monomers and/or macromonomers. A polymer typically comprises repetition of a number of constitutional units.

The terms “monomer” or “macromonomer” as used herein refer to a chemical entity that may be covalently linked to one or more of such entities to form a polymer.

The term “bond” refers to a linkage between atoms in a compound or molecule. The bond may be a single bond, a double bond, or a triple bond.

In the definitions of a number of substituents below, it is stated that “the group may be a terminal group or a bridging group”. This is intended to signify that the use of the term is intended to encompass the situation where the group is a terminal group/moiety as well as the situation where the group is a linker between two other portions of the molecule. Using the term “alkyl” having 1 carbon atom as an example, it will be appreciated that when existing as a terminal group, the term “alkyl” having 1 carbon atom may mean —CH₃ and when existing as a bridging group, the term “alkyl” having 1 carbon atom may mean —CH₂— or the like.

The term “ester” or the like is intended to broadly refer to a group containing —O—C(═O)— or —C(═O)OR where R is independently a hydrogen or an organic group. The group may be a terminal group or a bridging group.

The term “alkyl” as a group or part of a group refers to a straight or branched aliphatic hydrocarbon group having 1 to 20 carbon atoms, 1 to 10 carbon atoms, 1 to 6 carbon atoms, or 1, 2, 3, 4, 5, 6, 7, 8, 9, 10, 11, 12, 13, 14, 15, 16, 17, 18, 19 or 20 carbon atoms. Examples of suitable straight and branched alkyl substituents include methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl and the like. The group may be a terminal group or a bridging group.

The term “alkenyl” as a group or part of a group denotes an aliphatic hydrocarbon group containing at least one carbon-carbon double bond and which may be straight or branched having 2 to 20 carbon atoms, 2 to 10 carbon atoms, 2 to 6 carbon atoms, or 2, 3, 4, 5, 6, 7, 8, 9, 10, 11, 12, 13, 14, 15, 16, 17, 18, 19 or 20 carbon atoms in the chain. The group may contain a plurality of double bonds and the orientation about each double bond is independently E or Z. Exemplary alkenyl groups include, but are not limited to, ethenyl, vinyl, allyl, 1-methylvinyl, 1-propenyl, 2-propenyl, 2-methyl-1-propenyl, 2-methyl-1-propenyl, 1-butenyl, 2-butenyl, 3-butentyl, 1,3-butadienyl, 1-pentenyl, 2-pententyl, 3-pentenyl, 4-pentenyl, 1,3-pentadienyl, 2,4-pentadienyl, 1,4-pentadienyl, 3-methyl-2-butenyl, 1-hexenyl, 2-hexenyl, 3-hexenyl, 1,3-hexadienyl, 1,4-hexadienyl, 2-methylpentenyl, 1-heptenyl, 2-heptentyl, 3-heptenyl, 1-octenyl, 2-octenyl, 3-octenyl, 1-nonenyl, 2-nonenyl, 3-nonenyl, 1-decenyl, 2-decenyl, 3-decenyl and the like. The group may be a terminal group or a bridging group.

The term “alkynyl” as a group or part of a group denotes an aliphatic hydrocarbon group containing at least one carbon-carbon triple bond and which may be straight or branched having 2 to 20 carbon atoms, 2 to 10 carbon atoms, 2 to 6 carbon atoms, or 2, 3, 4, 5, 6, 7, 8, 9, 10, 11, 12, 13, 14, 15, 16, 17, 18, 19 or 20 carbon atoms in the chain. The group may contain a plurality of triple bonds. Exemplary alkynyl groups include, but are not limited to, acetylenyl, propynyl, 1-butynyl, 2-butynyl, 3-butynyl, 1-pentynyl, 2-pentynyl, 3-methyl-1-butynyl, 4-pentynyl, 1-hexynyl, 2-hexynyl, 5-hexynyl, 1-heptynyl, 2-heptynyl, 6-heptynyl, 1-octynyl, 2-octynyl, 7-octynyl, 1-nonynyl, 2-nonynyl, 8-nonynyl, 1-decynyl, 2-decynyl, 9-decynyl and the like. The group may be a terminal group or a bridging group.

The term “alkoxy” as used herein refers to straight chain or branched alkyloxy groups. Examples include methoxy, ethoxy, n-propoxy, isopropoxy, tert-butoxy, and the like.

The term “cycloalkyl” refers to a saturated monocyclic or fused or spiro polycyclic, carbocycle preferably having 3 to 9, or 3, 4, 5, 6, 7, 8 or 9 carbon atoms per ring, such as cyclopropyl, cyclobutyl, cyclopentyl, cyclohexyl and the like. It includes monocyclic systems such as cyclopropyl and cyclohexyl, bicyclic systems such as decalin, and polycyclic systems such as adamantine. The group may be a terminal group or a bridging group.

The term “aryl” as a group or part of a group denotes (i) an optionally substituted monocyclic, or fused polycyclic, aromatic carbocycle (ring structure having ring atoms that are all carbon) preferably having from 5 to 20, or 5, 6, 7, 8, 9, 10, 11, 12, 13, 14, 15, 16, 17, 18, 19 or 20 carbon atoms per ring. Examples of aryl groups include phenyl, naphthyl, and the like; (ii) an optionally substituted partially saturated bicyclic aromatic carbocyclic moiety in which a phenyl and a —C₅₋₇-cycloakyl or —C₅₋₇-cycloalkenyl groups are fused together to form a cyclic structure, such as tetrahydronaphthyl, indenyl or indanyl. The group may be a terminal group or a bridging group. Typically, an aryl group is a C₆-C₁₈ aryl group.

The term “heteroaryl” either alone or part of a group refers to groups containing an aromatic ring (preferably a 5- or 6-membered aromatic ring) having one or more heteroatoms as ring atoms in the aromatic ring with the remainder of the ring atoms being carbon atoms. Suitable heteroatoms may include nitrogen, oxygen and sulfur. Examples of heteroaryl include thiophene, benzothiophene, benzofuran, benzimidazole, benzoxazole, benzothiazole, benzisothiazole, naphtha[2,3-b]thiophene, furan, isoindolizine, xantholene, phenoxatine, pyrrole, imidazole, pyrazole, pyridine, pyrazine, pyrimidine, pyridazine, tetrazole, indole, isoindole, 1H-indazole, purine, quinoline, isoquinoline, phthalazine, naphthyridine, quinoxaline, cinnoline, carbazole, phenantridine, acridine, phenazine, thiazole, isothiazole, phenothiazine, oxazole, isooxazole, furazane, phenoxazine, 2-, 3- or 4-pyridyl, 2-, 3-, 4-, 5-, or 8-quinolyl, 1-, 3-, 4-, or 5-isoquinolinyl 1-, 2-, or 3-indolyl, and 2-, or 3-thienyl. The group may be a terminal group or a bridging group.

The term “heterocyclic” refers to saturated, partially unsaturated or fully unsaturated monocyclic, bicyclic or polycyclic ring system containing at least one heteroatom selected from the group consisting of nitrogen, sulfur and oxygen as a ring atom. Examples of heterocyclic moieties include heterocycloalkyl, heterocycloalkenyl and heteroaryl.

The term “halogen” represents chlorine, fluorine, bromine or iodine. The term “halo” represents chloro, fluoro, bromo or iodo.

The term “amine group” or the like is intended to broadly refer to a group containing —NR₂, where R is independently a hydrogen or an organic group. The group may be a terminal group or a bridging group.

The term “amide group” or the like is intended to broadly refer to a group containing —C(═O)NR₂, where R is independently a hydrogen or an organic group. The group may be a terminal group or a bridging group.

The term “optionally substituted,” when used to describe a chemical structure or moiety, refers to the chemical structure or moiety wherein one or more of its hydrogen atoms is optionally substituted with a chemical moiety or functional group such as alcohol, alkoxy, alkanoyloxy, alkoxycarbonyl, alkenyl, alkyl (e.g., methyl, ethyl, propyl, t-butyl), alkynyl, alkylcarbonyloxy (—OC(O)alkyl), amide (—C(O)NH-alkyl- or -alkylNHC(O)alkyl), amine (such as alkylamino, arylamino, arylalkylamino), aryl, aryloxy, azo, carbamoyl (—NHC(O)O-alkyl- or —OC(O)NH-alkyl), carbamyl (e.g., CONH₂, as well as CONH-alkyl, CONH-aryl, and CONH-arylalkyl), carboxyl, carboxylic acid, cyano, ester, ether (e.g., methoxy, ethoxy), halo, haloalkyl (e.g., —CCl₃, —CF₃, —C(CF₃)₃), heteroalkyl, isocyanate, isothiocyanate, nitrile, nitro, phosphodiester, sulfide, sulfonamido (e.g., SO₂NH₂), sulfone, sulfonyl (including alkylsulfonyl, arylsulfonyl and arylalkylsulfonyl), sulfoxide, thiol (e.g., sulfhydryl, thioether) or urea (—NHCONH-alkyl-).

The term “micro” as used herein is to be interpreted broadly to include dimensions from about 1 micron to about 1000 microns.

The term “nano” as used herein is to be interpreted broadly to include dimensions less than about 1000 nm, less than about 500 nm, less than about 100 nm or less than about 50 nm.

The terms “coupled” or “connected” as used in this description are intended to cover both directly connected or connected through one or more intermediate means, unless otherwise stated.

The term “associated with”, used herein when referring to two elements refers to a broad relationship between the two elements. The relationship includes, but is not limited to a physical, a chemical or a biological relationship.

For example, when element A is associated with element B, elements A and B may be directly or indirectly attached to each other or element A may contain element B or vice versa.

The term “adjacent” used herein when referring to two elements refers to one element being in close proximity to another element and may be but is not limited to the elements contacting each other or may further include the elements being separated by one or more further elements disposed therebetween.

The term “and/or”, e.g., “X and/or Y” is understood to mean either “X and Y” or “X or Y” and should be taken to provide explicit support for both meanings or for either meaning.

Further, in the description herein, the word “substantially” whenever used is understood to include, but not restricted to, “entirely” or “completely” and the like. In addition, terms such as “comprising”, “comprise”, and the like whenever used, are intended to be non-restricting descriptive language in that they broadly include elements/components recited after such terms, in addition to other components not explicitly recited. For example, when “comprising” is used, reference to a “one” feature is also intended to be a reference to “at least one” of that feature. Terms such as “consisting”, “consist”, and the like, may in the appropriate context, be considered as a subset of terms such as “comprising”, “comprise”, and the like. Therefore, in embodiments disclosed herein using the terms such as “comprising”, “comprise”, and the like, it will be appreciated that these embodiments provide teaching for corresponding embodiments using terms such as “consisting”, “consist”, and the like. Further, terms such as “about”, “approximately” and the like whenever used, typically means a reasonable variation, for example a variation of +/−5% of the disclosed value, or a variance of 4% of the disclosed value, or a variance of 3% of the disclosed value, a variance of 2% of the disclosed value or a variance of 1% of the disclosed value.

Furthermore, in the description herein, certain values may be disclosed in a range. The values showing the end points of a range are intended to illustrate a preferred range. Whenever a range has been described, it is intended that the range covers and teaches all possible sub-ranges as well as individual numerical values within that range. That is, the end points of a range should not be interpreted as inflexible limitations. For example, a description of a range of 1% to 5% is intended to have specifically disclosed sub-ranges 1% to 2%, 1% to 3%, 1% to 4%, 2% to 3% etc., as well as individually, values within that range such as 1%, 2%, 3%, 4% and 5%. The intention of the above specific disclosure is applicable to any depth/breadth of a range.

Additionally, when describing some embodiments, the disclosure may have disclosed a method and/or process as a particular sequence of steps. However, unless otherwise required, it will be appreciated that the method or process should not be limited to the particular sequence of steps disclosed. Other sequences of steps may be possible. The particular order of the steps disclosed herein should not be construed as undue limitations. Unless otherwise required, a method and/or process disclosed herein should not be limited to the steps being carried out in the order written. The sequence of steps may be varied and still remain within the scope of the disclosure.

Furthermore, it will be appreciated that while the present disclosure provides embodiments having one or more of the features/characteristics discussed herein, one or more of these features/characteristics may also be disclaimed in other alternative embodiments and the present disclosure provides support for such disclaimers and these associated alternative embodiments.

### DESCRIPTION OF EMBODIMENTS

Exemplary, non-limiting embodiments of a method for preparing a polymer having ester functionality and said polymer prepared therefrom are disclosed hereinafter.

In various embodiments, there is provided a method for preparing a polymer having ester functionality, e.g., in the backbone of the polymer. In various embodiments, the method comprises reacting/polymerizing/copolymerizing a mixture of monomers that comprises/consists essentially of/consists of: (i) at least one first acrylate and/or methacrylate monomer; (ii) at least one cyclic ketene acetal monomer; and (iii) at least one additional monomer selected from the group consisting of a second acrylate and/or methacrylate monomer that is functionalized with hydrophilic groups, a vinylic monomer that is functionalized with hydrophilic groups, and combinations thereof, to obtain the polymer. The polymer may comprise acrylate polymer, methacrylate polymer, acrylic, polyacrylate, polymethacrylate and/or poly(meth)acrylate. Advantageously, embodiments of the method are capable of introducing/incorporating ester functional groups into the polymer under aqueous conditions. Even more advantageously, embodiments of the method disclosed herein allow monomers that are sensitive to/unstable in water (e.g., cyclic ketene acetal monomer) to be effectively incorporated into the polymer. It will be appreciated that being able to successfully perform polymerization in aqueous medium using monomers that are sensitive to/unstable in water or successfully incorporate monomers that are sensitive to/unstable in water into a polymer without said monomers substantially undergoing hydrolysis is by no means trivial. It will be appreciated that it is not expected for cyclic ketene acetal monomers to withstand reactions (e.g., polymerization) in water since cyclic ketene acetal monomers inherently lack stability in water and generally undergoes hydrolysis under acidic, neutral and basic conditions in water.

In various embodiments, the polymer is in the form of a polymer latex or a polymer emulsion. The polymer may comprise polymer/polymeric particles (e.g., polymer/polymeric nano-sized particles or nanoparticles). In various embodiments, the polymer comprises particles having an average size (Z-average or number mean) of from about 50 nm to about 500 nm, from about 60 nm to about 450 nm, from about 70 nm to about 400 nm, from about 80 nm to about 350 nm, from about 90 nm to about 300 nm, from about 100 nm to about 250 nm, or from about 150 nm to about 200 nm. In various embodiments, the particles are spherical, round or circular in shape.

In various embodiments, the polymer comprises a plurality of ester functionality in the backbone of the polymer. In various embodiments, the ester functionality is uniformly/occasionally/sporadically/infrequently distributed along/in/throughout the backbone. Advantageously, the presence of the ester functionality/groups in the backbone of the polymer imparts degradability and/or biodegradability properties to the polymer, making the polymer ideal/attractive for use in various applications (e.g., sustainable, environmentally friendly and/or green applications), minimizing waste accumulation and/or plastic leaching/leakage into the environment. In various embodiments, degradation of the polymer occurs at the ester functionality/groups present in the backbone of the polymer. That is, in various embodiments, the ester bonds are cleavable/degradable and can be cleaved/degraded/broken down into its simpler forms, e.g., oligomer(s), monomer(s) and/or smaller molecule(s) having a molecular mass that is lower than the polymer. Accordingly, the polymer may be a degradable polymer, cleavable polymer or a degradable ester-containing polymer latex. In various embodiments, the polymer is degradable and/or cleavable upon exposure to water and/or environmental conditions, e.g., by hydrolysis or hydrolytic reactions.

The method may be aqueous/water-based. The reaction/emulsion mixture/system may be an aqueous or a water mixture/system of monomers. In various embodiments, the polymer having ester functionality is prepared/synthesized/polymerized in aqueous media (e.g., in an aqueous medium such as deionized water). In various embodiments, the entire method is carried out using an aqueous medium such as deionized water as the primary medium. Thus, various embodiments of the method disclosed herein is completely different from methods that require the synthesis of polymer or polymerization to be carried out in non-aqueous media or methods that require to work under water-free conditions. Advantageously, carrying out the reacting/polymerizing/copolymerizing process/steps in aqueous/water-based media is safe, non-toxic, green and environmentally friendly/benign as compared to methods using polymerization techniques that typically utilize harsh and/or environmentally unfriendly chemicals. Accordingly, in various embodiments, the step of reacting/polymerizing/copolymerizing a mixture of monomers to obtain the polymer is substantially devoid of an organic/non-aqueous medium or solvent (e.g., to dissolve one or more monomers, reactants or reagents) or a reactant (surfactant not taken into account; e.g., that may be required for a chemical reaction to take place). In various embodiments, the entire method is substantially devoid of an organic/non-aqueous solvent or medium.

In various embodiments, the method does not require and/or is substantially devoid of the use of high shear mixing and/or new or complex/sophisticated equipment. Advantageously, in various embodiments, the method utilizes a simple and straightforward polymerization set up. For example, the method may be carried out by using a conventional emulsion polymerization set up and is still capable of preparing chemically degradable latex suspensions that is comparable with/similar to commercial latex suspension in water. Advantageously, embodiments of the method disclosed herein have a high production yield, high monomer incorporation rate, high scalability (e.g., production can be scaled up to litres at an industrial scale) and/or high versatility (e.g., can be used for a wide range of latex applications).

Various embodiments of the present disclosure include a method for preparing acrylate polymers having ester functionality in the backbone by emulsion polymerization and said polymer prepared therefrom.

In various embodiments, the step of reacting/polymerizing/copolymerizing is carried out in the presence of an initiator or a radical source. Advantageously, the presence of an initiator promotes/initiates synthesis/polymerization reactions of the polymer, for e.g., by facilitating the formation/generation of radicals.

In various embodiments, the initiator or a radical source comprises an initiator that has a high stability and/or remains substantially stable at an alkaline/basic pH. The initiator may remain substantially stable at a pH value of from about 8.0 to about 14.0, from about 8.5 to about 13.5, from about 9.0 to 13.0, from about 9.5 to about 12.5, from about 10.0 to about 12.0, from about 10.5 to about 11.5, or about 11.0. In various embodiments, the initiator initiates polymerization process/reaction in water. It will be appreciated that the initiation (and polymerization reaction) is a competing reaction with respect to hydrolysis reaction in water. Thus, advantageously, in various embodiments, the presence of the initiator helps/serves to prevent water-sensitive monomers (e.g., cyclic ketene acetal monomers that are known to be sensitive to/unstable in water) from undergoing hydrolysis. Without being bound by theory, it is believed that hydrolysis of water-sensitive monomers is reduced/suppressed/prevented due to the initiation (and polymerization reaction) being favoured over hydrolysis reaction in water, thereby decreasing availability of water to the water-sensitive monomers. In various embodiments, the initiator comprises an initiator that has a half-life of at least about 3.0 hours, at least about 3.5 hours, at least about 4.0 hours, at least about 4.5 hours, at least about 5.0 hours, at least about 5.5 hours, at least about 6.0 hours, at least about 6.5 hours, at least about 7.0 hours, at least about 7.5 hours, at least about 8.0 hours, at least about 8.5 hours, at least about 9.0 hours, at least about 9.5 hours, at least about 10.0 hours, at least about 11.0 hours, at least about 12.0 hours, at least about 13.0 hours, at least about 14.0 hours, at least about 15.0 hours, at least about 16.0 hours, at least about 17.0 hours, at least about 18.0 hours, at least about 19.0 hours, at least about 20.0 hours, at least about 25.0 hours, at least about 30.0 hours, at least about 35.0 hours, at least about 40.0 hours, at least about 45.0 hours, or at least about 50.0 hours at a temperature of from about 40° C. to about 100° C., from about 45° C. to about 95° C., from about 50° C. to about 90° C., from about 55° C. to about 85° C., from about 60° C. to about 80° C., from about 65° C. to about 75° C., or at about 70° C. It will be appreciated that various initiators having a half-life of at least about 3 hours at a temperature of from about 40° C. to about 100° C. may be used in embodiments of the method disclosed herein. Advantageously, in various embodiments, the initiator having a half-life of at least about 3.0 hours provides good amount of radical flux throughout the reaction time for initiating reaction (e.g., polymerization reaction). Advantageously, in various embodiments, the initiator provides a constant radical flux at the conditions (e.g., pH and temperature conditions) employed for the step of reacting/polymerizing/copolymerizing. For example, a constant radical flux may be provided by the initiator at a temperature of from about 40° C. to about 100° C. and at a pH value of from about 8.0 to about 14.0 employed during polymerization. In various embodiments, due to the long/high half-life, the initiator decomposes slowly and/or produces radicals gradually in the emulsion system. Without being bound by theory, it is believed that the slow decomposition of the initiator and/or gradual production of radicals from the initiator in the emulsion system may help/aid in incorporating the cyclic ketene acetal monomers into the polymer backbone. It is also believed that such a slow decomposition and/or gradual production of radicals from the initiator may help/aid in the formation of stable particles during emulsion polymerization.

In various embodiments, the initiator or a radical source comprises an initiator that is capable of being dissolved substantially in water. Accordingly, in various embodiments, the initiator comprises water-soluble compound/salt. The initiator may be selected from persulfate salts (for e.g., sodium persulfate (Na₂S₂O₈), potassium persulfate (KPS) (K₂S₂O₈) and ammonium persulfate (APS) (NH₄)₂S₂O₈)) and/or azo compounds (for e.g., 2,2′-Azobis(2-methylpropionamidine)dihydrochloride (or V-50), 2,2′-Azobis[2-(2-imidazolin-2-yl)propane]dihydrochloride (or VA-044) and 2,2′-Azobis[2-methyl-N-(2-hydroxyethyl)propionamide](or VA-086)). For example, the initiator may be ammonium persulfate (APS) which is a pH dependent initiator, has a half-life of about 10 hours at 70° C., and is water soluble. In some embodiments, the method comprises the use of only ammonium persulfate (APS) as the initiator.

Accordingly, in various embodiments, the method is substantially devoid of the use of compounds such as iron(II) sulfate heptahydrate (FeSO₄·7H₂O) and/or ethylenediaminetetraacetic acid (EDTA) and/or tert-butyl hydroperoxide (t-BHP) as the initiator. Thus, various embodiments of the methods disclosed herein are completely different from methods that require iron(II) sulfate heptahydrate (FeSO₄·7H₂O) and/or ethylenediaminetetraacetic acid (EDTA) and/or tert-butyl hydroperoxide (t-BHP) in the aqueous mixture before polymerization.

In various embodiments, the step of reacting/polymerizing/copolymerizing comprises mixing the mixture of monomers with an initiator to form an emulsion/reaction mixture/system. Accordingly, in various embodiments, the emulsion/reaction mixture comprises an initiator. For example, the emulsion/reaction mixture may comprise the initiator added in a concentration of from about 0.1 wt % to about 20 wt % with respect to the total weight of the monomers. The concentration of the initiator may be from about 0.1 wt % to about 20.0 wt %, about 0.5 wt % to about 19.0 wt %, about 1.0 wt % to about 18.0 wt %, about 2.0 wt % to about 17.0 wt %, about 3.0 wt % to about 16.0 wt %, about 4.0 wt % to about 15.0 wt %, about 5.0 wt % to about 14.0 wt %, about 6.0 wt % to about 13.0 wt %, about 7.0 wt % to about 12.0 wt %, about 8.0 wt % to about 11.0 wt %, or about 9.0 wt % to about 10.0 wt % with respect to the total weight of the monomers. The concentration of the initiator may be about 6.0 wt % with respect to the total weight of the monomers.

In various embodiments, the step of reacting/polymerizing/copolymerizing is carried out in the presence of a surfactant. In various embodiments, the surfactant comprises hydrophilic group(s) and lipophilic group(s). Advantageously, the presence of hydrophilic group(s) and lipophilic group(s) in the surfactant aids in the synthesis/polymerization reactions of the polymer via stabilization and growth of the radical polymer particles (e.g., radical polymer nanoparticles). Without being bound by theory, it is believed that hydrophilic-lipophilic balance (HLB) and/or orientation of hydrophilic and lipophilic groups in the surfactant may advantageously help/aid in stabilizing and/or growing radical polymer particles in continuous phase. HLB value is an arbitrary scale between 0 and 20 which measures the size and strength of the polar portion relative to the non-polar portion of the non-ionic surfactant molecule, where 0 is completely lipophilic and 20 is completely hydrophilic. In various embodiments, the surfactant has a hydrophilic-lipophilic balance (HLB) of from about 7.0 to about 20.0, from about 8.0 to about 19.0, from about 9.0 to about 18.0, from about 10.0 to about 17.0, from about 11.0 to about 16.0, from about 12.0 to about 15.0, or from about 13.0 to about 14.0. It will be appreciated that various surfactants having a HLB of from about 7.0 to about 20.0 may be used in embodiments of the method disclosed herein. For example, the surfactant may comprise Triton X-114 having a HLB=12.4 and/or Triton X-100 having a HLB=13.5. It will also be appreciated that various surfactants having a structure and/or HLB similar/close to that of Triton X-114 or Triton X-100 may be used in embodiments of the method disclosed herein.

In some embodiments, the surfactant has a hydrophilic-lipophilic balance (HLB) of from about 7.0 to about 16.0. The surfactant may have a hydrophilic-lipophilic balance (HLB) of from about 7.0 to about 16.0, from about 8.0 to about 16.0, from about 9.0 to about 16.0, from about 10.0 to about 16.0, from about 11.0 to about 16.0, about 11.1, about 11.2, about 11.3, about 11.4, about 11.5, about 11.6, about 11.7, about 11.8, about 11.9, about 12.0, about 12.1, about 12.2, about 12.3, about 12.4, about 12.5, about 12.6, about 12.7, about 12.8, about 12.9, about 13.0, about 13.1, about 13.2, about 13.3, about 13.4, about 13.5, about 13.6, about 13.7, about 13.8, about 13.9, about 14.0, about 14.1, about 14.2, about 14.3, about 14.4, about 14.5, about 14.6, about 14.7, about 14.8, about 14.9, about 15.0, about 15.1, about 15.2, about 15.3, about 15.4, about 15.5, about 15.6, about 15.7, about 15.8, about 15.9, or about 16.0. Advantageously, by using surfactants having HLB of from about 7.0 to about 16.0 in the method disclosed herein, stable oil in water emulsions are formed. For example, in such embodiments, the orientation of the hydrophilic/lipophilic groups in the surfactant is such that hydrophilic part of the surfactant is orientated towards the water and the lipophilic part of the surfactant is orientated towards the oil at the interface between the aqueous medium and the oil droplet, thereby effectively stabilizing the oil in water emulsion. On the contrary, it will be appreciated that surfactants with HLB outside the range of from about 7.0 to about 16.0 may not be able to form stable oil in water emulsion.

In various embodiments, the method is substantially devoid of the use of one or more surfactants having a HLB of less than about 7.0, less than about 6.0, less than about 5.0, less than about 4.0, or less than about 3.0. For example, the method may be substantially devoid of the use of Span® 85 (e.g., sorbitan fatty acid ester or sorbitan trioleate) which has a HLB of about 1.8. In various embodiments, the method is substantially devoid of the use of one or more surfactants having a HLB of more than about 17.0, more than about 18.0, more than about 19.0, or more than about 20.0. For example, the method may be substantially devoid of the use of Triton X-405 (e.g., octylphenol ethoxylate, polyethylene glycol tert-octylphenyl ether, polyoxyethylene (40) isooctylphenyl ether, polyoxyethylene (40) isooctylcyclohexyl ether, 4-(1,1,3,3-tetramethylbutyl)phenyl-polyethylene glycol solution) which has a HLB of about 17.6.

Advantageously, in various embodiments, the presence of the surfactant allows the polymerization (e.g., polymer chain growth) to happen/occur in the surfactant micelle, thereby leading to nanometer sized polymer particles. Accordingly, embodiments of the presently disclosed method do not require high energy mixing during/in emulsion polymerization. Therefore, in various embodiments, it will be appreciated that the method disclosed herein is completely different from methods that require/use a mini emulsion approach (e.g., where high energy/shear mixing/homogenization or ultrasonication is required for the purposes of obtaining monomer droplets in order to have the polymerization occurs inside the droplet for preparing nanometer sized oil droplets prior to polymerization).

In various embodiments, the surfactant comprises a neutral/non-ionic surfactant. In various embodiments, the surfactant comprises a surfactant that has one or more fatty acid ester chain(s) and/or one or more poly(ethylene glycol)/polyoxyethylene chain(s). In various embodiments, the surfactant comprises a neutral surfactant having fatty acid ester chains. For example, the surfactant may be sugar ester surfactants selected from sorbitan esters (e.g., sorbitan oleate/sorbitane monooleate (or Span® 80)) or sucrose esters (e.g., sucrose stearate/sucrose monostearate, sucrose palmitate, sucrose laurate, sucrose behenate, sucrose oleate, sucrose erucate or sucrose fatty acid esters (or Ryoto Sugar Ester)). In various embodiments, the surfactant comprises a neutral surfactant having poly(ethylene glycol) chains. For example, the surfactant may be octylphenol polyethoxylated surfactants (e.g., members of the Triton family including Triton™ X-100, Triton™ X-114), polyoxyethylene surfactant (e.g., Brij® L23), poloxamers (e.g., poly(ethylene glycol)-block-poly(propylene glycol)-block-poly(ethylene glycol) (or Poloxamer 188)), poly(ethylene glycol)-b-poly(s-caprolactone) (PEG-b-PCL)) or combinations thereof. In various embodiments, the surfactant comprises a neutral surfactant having both poly(ethylene glycol) chains and fatty acid ester chains. For example, the surfactant comprises polysorbate surfactants (e.g., members of the Tween family including Tween 20 and Tween 80). In various embodiments, the method is substantially devoid of the use of one or more surfactants selected from the group consisting of Triton X-405 (e.g., octylphenol ethoxylate, polyethylene glycol tert-octylphenyl ether, polyoxyethylene (40) isooctylphenyl ether, polyoxyethylene (40) isooctylcyclohexyl ether, 4-(1,1,3,3-tetramethylbutyl)phenyl-polyethylene glycol solution) and Span® 85 (e.g., sorbitan fatty acid ester or sorbitan trioleate).

In various embodiments, the step of reacting/polymerizing/copolymerizing comprises mixing the mixture of monomers with a surfactant to form an emulsion/reaction mixture/system. Accordingly, in various embodiments, the emulsion/reaction mixture comprises a surfactant. In various embodiments, the emulsion/reaction mixture comprises the surfactant added in a concentration of from about 0.01 wt % to about 10.0 wt % with respect to the weight of the total emulsion/reaction mixture. The concentration of the surfactant may be from about 0.01 wt % to about 10.0 wt %, 0.02 wt % to about 9.5 wt %, about 0.05 wt % to about 9.0 wt %, about 0.1 wt % to about 8.5 wt %, about 0.2 wt % to about 8.0 wt %, about 0.3 wt % to about 7.5 wt %, about 0.4 wt % to about 7.0 wt %, about 0.5 wt % to about 6.5 wt %, about 0.6 wt % to about 6.0 wt %, about 0.7 wt % to about 5.5 wt %, about 0.8 wt % to about 5.0 wt %, about 0.9 wt % to about 4.5 wt %, about 1.0 wt % to about 4.0 wt %, about 1.5 wt % to about 3.5 wt %, about 2.0 wt % to about 3.0 wt %, or about 2.5 wt % with respect to weight of the total emulsion/reaction mixture. For example, the concentration of the surfactant may be about 0.5 wt % with respect to the weight of the total emulsion/reaction mixture.

In various embodiments, the step of reacting/polymerizing/copolymerizing is carried out in the presence of a base. In various embodiments, the base comprises an inorganic and/or strong base. The base may be selected from sodium hydroxide (NaOH), potassium hydroxide (KOH), sodium carbonate (Na₂CO₃), potassium carbonate (K₂CO₃), sodium bicarbonate (NaHCO₃), potassium bicarbonate (KHCO₃), ammonium hydroxide (NH₄OH) or mixtures thereof. It will be appreciated that any suitable base that effectively results in an increase in the overall pH of the solution/mixture (e.g., aqueous solution/mixture or emulsion/reaction mixture/system) may be used in embodiments of the method disclosed herein.

In various embodiments, the step of reacting/polymerizing/copolymerizing comprises mixing the mixture of monomers with a base to form an emulsion/reaction mixture/system. Accordingly, in various embodiments, the emulsion/reaction mixture comprises a base. In various embodiments, the emulsion/reaction mixture comprises the base added in a concentration/amount such that the pH of the emulsion/reaction mixture is controlled/adjusted/maintained at an alkaline/basic pH. For example, the concentration/amount of base may be added such that pH value of the emulsion/reaction mixture is controlled/adjusted/maintained at a pH that falls in the range of from about 8.0 to about 14.0, from about 8.5 to about 13.5, from about 9.0 to 13.0, from about 9.5 to about 12.5, from about 10.0 to about 12.0, from about 10.5 to about 11.5, or about 11.0. The concentration/amount of base may be added such that pH value of the emulsion/reaction mixture is controlled/adjusted/maintained at a pH that is about 8.0, about 8.1, about 8.2, about 8.3, about 8.4, about 8.5, about 8.6, about 8.7, about 8.8, about 8.9, about 9.0, about 9.1, about 9.2, about 9.3, about 9.4, about 9.5, about 9.6, about 9.7, about 9.8, about 9.9, about 10.0, about 10.1, about 10.2, about 10.3, about 10.4, about 10.5, about 10.6, about 10.7, about 10.8, about 10.9, about 11.0, about 11.1, about 11.2, about 11.3, about 11.4, about 11.5, about 11.6, about 11.7, about 11.8, about 11.9, about 12.0, about 12.1, about 12.2, about 12.3, about 12.4, about 12.5, about 12.6, about 12.7, about 12.8, about 12.9, about 13.0, about 13.1, about 13.2, about 13.3, about 13.4, about 13.5, about 13.6, about 13.7, about 13.8, about 13.9, or about 14.0. In various embodiments, the emulsion/reaction mixture comprises the base added in a concentration of from about 0.01 wt % to about 10.0 wt % with respect to the weight of the total emulsion/reaction mixture. For example, the concentration of the base may be from about 0.01 wt % to about 10.0 wt %, 0.02 wt % to about 9.5 wt %, about 0.05 wt % to about 9.0 wt %, about 0.1 wt % to about 8.5 wt %, about 0.2 wt % to about 8.0 wt %, about 0.3 wt % to about 7.5 wt %, about 0.4 wt % to about 7.0 wt %, about 0.5 wt % to about 6.5 wt %, about 0.6 wt % to about 6.0 wt %, about 0.7 wt % to about 5.5 wt %, about 0.8 wt % to about 5.0 wt %, about 0.9 wt % to about 4.5 wt %, about 1.0 wt % to about 4.0 wt %, about 1.5 wt % to about 3.5 wt %, about 2.0 wt % to about 3.0 wt %, or about 2.5 wt % with respect to weight of the total emulsion/reaction mixture. Advantageously, in various embodiments, controlling/adjusting/maintaining the pH of the emulsion/reaction mixture/system at a high pH (e.g., pH that is greater than about 8.0) may help prevent or minimize water-sensitive monomers (e.g., cyclic ketene acetal monomers that are known to be sensitive to/unstable in water) from undergoing hydrolysis.

In various embodiments, the initially formed emulsion/reaction mixture/system has a pH ≥12. As the reaction/polymerization/copolymerization proceeds/progresses, the pH of the emulsion/reaction mixture may fall/decrease to a pH range of from about 8.0 to about 11.0 or from about 8.5 to about 11.5 (for e.g., within 5 minutes, 10 minutes or 15 minutes from the start of the reaction). For example, in some embodiments, the reaction pH may drop very fast to a pH of less than about 12.0, less than about 11.5, less than about 11.0, less than about 10.5, less than about 10.0, less than about 9.5, less than about 9.0, less than about 8.5, or less than about 8.0. Accordingly, in various embodiments therefore, the step of reacting/polymerizing/copolymerizing comprises controlling/adjusting/maintaining the pH of the emulsion/reaction mixture/system at an alkaline/basic pH. In various embodiments, the pH value of the emulsion/reaction mixture is controlled/adjusted/maintained at a pH of about more than 8.0, from about 8.0 to about 14.0, from about 8.5 to about 13.5, from about 9.0 to 13.0, from about 9.5 to about 12.5, from about 10.0 to about 12.0, from about 10.5 to about 11.5, or about 11.0. The pH of the emulsion mixture may be controlled/adjusted/maintained through a controlled addition of the base at intervals. For example, the step of reacting/polymerizing/copolymerizing may comprise monitoring pH value of the emulsion/reaction mixture/system and adding additional base in a dropwise manner at regular intervals (e.g., at about 1-second intervals, about 2-seconds intervals, about 3-seconds intervals, about 4-seconds intervals, about 5-seconds intervals, about 6-seconds intervals, about 7-seconds intervals, about 8-seconds intervals, about 9-seconds intervals, about 10-seconds intervals, about 15-seconds intervals, about 20-seconds intervals, about 25-seconds intervals, about 30-seconds intervals, about 35-seconds intervals, about 40-seconds intervals, about 45-seconds intervals, about 50-seconds intervals, about 55-seconds intervals, about 60-seconds intervals, about 65-seconds intervals, about 70-seconds intervals, about 75-seconds intervals, about 80-seconds intervals, about 85-seconds intervals, about 90-seconds intervals, about 95-seconds intervals, about 100-seconds intervals, about 105-seconds intervals, about 110-seconds intervals, about 115-seconds intervals, about 120-seconds intervals, about 3-minutes intervals, about 4-minutes intervals, about 5-minutes intervals, about 6-minutes intervals, about 7-minutes intervals, about 8-minutes intervals, about 9-minutes intervals, about 10-minutes intervals, or about 15-minutes intervals). Advantageously, by controlling/adjusting/maintaining the pH of the emulsion/reaction mixture at basic/alkaline pH (e.g., from about 8.0 to about 11.0), the polymer chains are better stabilized, therefore enhancing/facilitating the polymerization/co-polymerization process.

Even more advantageously, stabilization of the polymer chains during polymerization/co-polymerization of the monomers may be enhanced/increased through the synergistic combination of the presence of surfactant and application of pH control/adjustment of the reaction mixture. Without being bound by theory, it is believed that the synergistic action between use of a high pH and neutral/non-ionic surfactant may allow for stabilization of polymer chains in micelles by the neutral/non-ionic surfactant. In various embodiments, the surfactant and pH control/adjustment of the reaction mixture to basic/alkaline pH (e.g., high pH) works synergistically with the hydrophilic monomers (e.g., second acrylate and/or methacrylate monomers having both hydrophobic and hydrophilic groups) to enhance the stabilization of the monomer/polymer (e.g., latex) particles during and/or after polymerization/copolymerization of the monomers.

In various embodiments, the step of reacting/polymerizing/copolymerizing is optionally carried out in the presence of a stabilizer or a stabilizing agent. Advantageously, the presence of a stabilizer aids in the synthesis/polymerization reactions of the polymer by stabilizing the polymer particles in the emulsion/reaction mixture and hence the synthesis/polymerization process. In various embodiments, the stabilizer comprises an ammonium salt/compound or a quaternary ammonium salt/compound or a polymeric stabilizer (e.g., a water-soluble polymer). The stabilizer may be selected from tributylammonium salts (for e.g., methyltributylammonium chloride (MTBAC) and methyltributylammonium bromide (MTBAB)), tetrabutylammonium salts (for e.g., tetrabutylammonium chloride (TBAC) and tetrabutylammonium bromide (TBAB)), poly(vinyl alcohol) (PVA) or combinations thereof. It will be appreciated that various stabilizers that effectively stabilizes the particles during polymerization (e.g., emulsion polymerization) may be used in embodiments of the method disclosed herein.

In various embodiments, the step of reacting/polymerizing/copolymerizing comprises optionally mixing the mixture of monomers with a stabilizer to form an emulsion/reaction mixture/system. Accordingly, in various embodiments, the emulsion/reaction mixture comprises a stabilizer. In various embodiments, the emulsion/reaction mixture comprises the stabilizer added in a concentration of from about 0.1 wt % to about 2.0 wt % with respect to the weight of the total emulsion/reaction mixture. The concentration of the stabilizer may be from about 0.1 wt % to about 2.0 wt %, from about 0.2 wt % to 1.9 wt %, from about 0.3 wt % to about 1.8 wt %, from about 0.4 wt % to 1.7 wt %, from about 0.5 wt % to about 1.6 wt %, from about 0.6 wt % to 1.5 wt %, from about 0.7 wt % to about 1.4 wt %, from about 0.8 wt % to 1.3 wt %, from about 0.9 wt % to about 1.2 wt %, or from about 1.0 wt % to 1.1 wt % with respect to the weight of the total emulsion/reaction mixture. For example, the concentration of the stabilizer may be about 0.79 wt % with respect to the weight of the total emulsion/reaction mixture.

In various embodiments, the step of reacting/polymerizing/copolymerizing is optionally carried out in the presence of a crosslinking agent or a crosslinking agent. Advantageously, the presence of a crosslinking agent may aid in the synthesis/polymerization reactions of the polymer by introducing crosslinks to the polymer. In various embodiments, the crosslinking agent comprises a methacrylate that is different from the first acrylate and/or methacrylate monomer and second acrylate and/or methacrylate monomer that is functionalized with hydrophilic groups. In various embodiments, the crosslinking agent is different from the first acrylate and/or methacrylate monomer. For example, it will be appreciated that the first acrylate and/or methacrylate monomer is to be incorporated into a main chain/block of the polymer during polymerization whereas the crosslinking agent is added to introduce/enhance crosslinking of the polymer (e.g., not incorporated into main chain/block of the polymer during polymerization).

The crosslinking agent may be selected from the group consisting of ethylene glycol dimethacrylate (EGDMA), allyl methacrylate (AMA), diethylene glycol dimethacrylate (DEGDMA), 1,4-butanediol dimethacrylate, 1,5-pentanediol dimethacrylate, 1,6-hexanediol dimethacrylate and combinations thereof. It will be appreciated that various crosslinking agents that effectively introduces crosslinks to the polymer during polymerization (e.g., emulsion polymerization) may be used in embodiments of the method disclosed herein.

In various embodiments, the step of reacting/polymerizing/copolymerizing comprises optionally mixing the mixture of monomers with a crosslinking agent to form an emulsion/reaction mixture/system. Accordingly, in various embodiments, the emulsion/reaction mixture comprises a crosslinking agent. In various embodiments, the emulsion/reaction mixture comprises the crosslinking agent added in a concentration of from about 0.1 wt % to about 2.0 wt % with respect to the total weight of the monomers. The concentration of the crosslinking agent may be from about 0.1 wt % to about 2.0 wt %, from about 0.2 wt % to 1.9 wt %, from about 0.3 wt % to about 1.8 wt %, from about 0.4 wt % to 1.7 wt %, from about 0.5 wt % to about 1.6 wt %, from about 0.6 wt % to 1.5 wt %, from about 0.7 wt % to about 1.4 wt %, from about 0.8 wt % to 1.3 wt %, from about 0.9 wt % to about 1.2 wt %, or from about 1.0 wt % to 1.1 wt % with respect to the total weight of the monomers.

In various embodiments, the step of reacting/polymerizing/copolymerizing is performed in the presence of: (a) initiator; (b) surfactant; (c) base; (d) optionally a stabilizer; and (e) optionally a crosslinking agent.

The step of reacting/polymerizing/copolymerizing may comprise:
(a-i) a step of adding the mixture of monomers with a mixture (or aqueous solution/mixture) containing initiator, surfactant, base, optionally a stabilizer, and optionally a crosslinking agent to form an emulsion/reaction mixture/system; and
(a-ii) a step of stirring the emulsion/reaction mixture/system to obtain the polymer (e.g. in the form of polymer latex). In various embodiments, the stirring step (a-ii) comprises controlling/adjusting/maintaining the pH of the emulsion/reaction mixture/system at an alkaline/basic pH (e.g., at a pH value of from about 8.0 to about 14.0, from about 8.5 to about 13.5, from about 9.0 to 13.0, from about 9.5 to about 12.5, from about 10.0 to about 12.0, from about 10.5 to about 11.5, or about 11.0). The pH of the emulsion/reaction mixture/system may be controlled/adjusted/maintained by adding additional base to the emulsion/reaction mixture/system. In various embodiments, the additional base is added in a controlled and/or dropwise manner at intervals.

The method may further comprise, prior to the step of reacting/polymerizing/copolymerizing, preparing an aqueous solution/mixture before adding with the mixture of monomers. For example, in some embodiments, the method may further comprise, prior to the step of reacting/polymerizing/copolymerizing:
(b-i) a step of adding base to a mixture of a surfactant, optionally a stabilizer and optionally a crosslinking agent in aqueous medium (e.g., deionized water) to form an aqueous solution/mixture (1) containing a surfactant, base, optionally a stabilizer, and optionally a crosslinking agent; and
(b-ii) a step of adding initiator in aqueous medium (e.g., deionized water) to aqueous solution/mixture (1) to form an aqueous solution/mixture (2) containing an initiator, surfactant, base, optionally stabilizer, and optionally a crosslinking agent.

In other embodiments, the method may further comprise, prior to the step of reacting/polymerizing/copolymerizing, mixing an initiator, surfactant, base, optionally a stabilizer and optionally a crosslinking agent in an aqueous medium (e.g., deionized water) to form an aqueous solution/mixture. In various embodiments, the aqueous solution/mixture containing the initiator, surfactant, base, optionally a stabilizer and optionally a crosslinking agent has a pH that is greater than about 8.0, a pH greater than about 9.0, a pH greater than about 10.0, or a pH in the range of from about 8.5 to about 10.5.

In various embodiments, the method is performed in an inert atmosphere or in the absence of reactive gases such as oxygen (e.g., dissolved oxygen). In various embodiments, steps (a-i), (a-ii), (b-i) and/or (b-ii) is performed in an inert atmosphere or in the absence of reactive gases such as oxygen (e.g., dissolved oxygen). Accordingly, in various embodiments, the method further comprises purging/bubbling an inert gas during and/or in between steps (a-i), (a-ii), (b-i) and/or (b-ii). The inert gas may be argon (Ar) or nitrogen (N₂). Purging of inert gas maintains an oxygen-free system through the polymerization process/duration/period and it will be appreciated that various inert gases may be used in embodiments of the method disclosed herein.

The step of reacting/polymerizing/copolymerizing and/or step of stirring may comprise warming/heating the emulsion/reaction mixture/system to a temperature that is from about 40° C. to about 100° C. For example, the reacting/polymerizing/copolymerizing step and/or stirring step may be performed at a temperature that is from about 40° C. to about 100° C., from about 45° C. to about 95° C., from about 50° C. to about 90° C., from about 55° C. to about 85° C., from about 60° C. to about 80° C., from about 65° C. to about 75° C., or about 70° C. In various embodiments, the reacting/polymerizing/copolymerizing step and/or stirring step is performed at a temperature of no more than about 100° C., no more than about 90° C., no more than about 80° C., or no more than about 70° C. In various embodiments, the reacting/polymerizing/copolymerizing step and/or stirring step may be performed at a temperature of about 70° C., while maintaining the pH of the emulsion at a pH value of more than about 8.0, more than about 9.0, more than about 10.0, or in the range of from about 8.5 to about 10.5. The reacting/polymerizing/copolymerizing step and/or stirring step may be performed over a time duration of about 1 minute, about 5 minutes, about 10 minutes, about 15 minutes, about 20 minutes, about 25 minutes, about 30 minutes, about 45 minutes, about 1 hour, about 2 hours, about 3 hours, about 4 hours, about 5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 1 day or about 2 days.

In various embodiments, the step of reacting/polymerizing/copolymerizing comprise one or more of the following reactions: emulsion polymerization, water-based polymerization, radical polymerization (e.g., free radical polymerization, free radical ring opening polymerisation) and ring opening polymerisation. In various embodiments, the polymer is formed via one or more of the following reactions: emulsion polymerization, water-based polymerization, radical polymerization (e.g., free radical polymerization, free radical ring opening polymerisation) and ring opening polymerisation. For example, the polymer may be an emulsion polymer/copolymer.

The method may further comprise one or more post reaction/polymerization/copolymerization steps. For example, the method may further comprise a step of purifying the polymer (e.g. polymer latex) formed in the emulsion/mixture to remove any impurities such as excess/free polymer particles. The step of purifying the polymer may comprise quenching the emulsion/mixture, cooling the emulsion/mixture, washing the emulsion/mixture, centrifuging the emulsion/mixture, filtering the emulsion/mixture, creaming the emulsion/mixture, allowing the emulsion/mixture to settle and/or subsequently decanting the emulsion/mixture etc. For example, the method may also further comprise a step of drying and/or heating the polymer under vacuum (e.g., in an oven). In various embodiments, the step of purifying/washing/centrifuging may be repeated once, twice or thrice with a washing medium. The washing medium may be an aqueous medium (e.g. deionized water). The method may also further comprise, prior to the step of purifying the polymer, performing an analysis (e.g., ¹H NMR analysis) on the product to establish or estimate reaction conversion. In various embodiments, the polymer obtained is substantially stable. For example, the polymer may be stored for further use.

In various embodiments, the emulsion/mixture is purified/washed/centrifuged until the pH of the emulsion/mixture is similar to or identical to the pH of aqueous medium (e.g., deionized water). Accordingly, in various embodiments, the pH of the emulsion/mixture obtained after purification/washing/centrifugation is similar to or identical to the pH of aqueous medium (e.g., deionized water). For example, the pH of the purified/washed/centrifuged emulsion/mixture is from about 5.0 to about 8.0, from about 5.1 to about 7.9, from about 5.2 to about 7.8, about 5.3 to about 7.7, from about 5.4 to about 7.6, from about 5.5 to about 7.5, from about 5.6 to about 7.4, about 5.7 to about 7.3, from about 5.8 to about 7.2, from about 5.9 to about 7.1, from about 6.0 to 7.0 from about 6.1 to about 6.9, about 6.2 to about 6.8, from about 6.3 to about 6.7, from about 6.4 to about 6.6, or about 6.5.

In various embodiments, the at least one first acrylate and/or methacrylate monomer is represented by general formula (1):

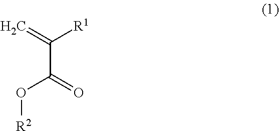

wherein
R¹ is selected from H or methyl (CH₃); and
R² is selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof.

In various embodiments, when R¹═H, general formula (I) comprises acrylate (e.g., acrylate ester). In various embodiments, when R¹=CH₃, general formula (I) comprises methacrylate (e.g., methacrylate ester).

In various embodiments, the method comprises a step of reacting/polymerizing/copolymerizing at least one, at least two, at least three, at least four, at least five, at least six, at least seven, at least eight, at least nine, or at least ten first acrylate and/or methacrylate monomers. The first acrylate and/or methacrylate monomers may comprise all acrylate monomers (i.e. where R¹=H), all methacrylate monomers (i.e. where R¹=CH₃), or a mixture of both acrylate and methacrylate monomers (i.e. where R¹=H and R¹=CH₃). For example, the polymer obtained may be an acrylate copolymer/acrylate emulsion copolymer (e.g., a copolymer comprising a single type or different types of acrylate monomers), a methacrylate copolymer/methacrylate emulsion copolymer (e.g., a copolymer comprising a single type or different types of methacrylate monomers), or an acrylate and methacrylate copolymer/acrylate and methacrylate emulsion copolymer (e.g., a copolymer comprising both acrylate and methacrylate monomers).

In various embodiments, R² is selected from C₁-C₂₀ alkyl. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, 2-ethylhexyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. R² may be straight or branched C₁-C₅ alkyl substituents.

In various embodiments, R² is selected from C₂-C₂₀ alkenyl, with the proviso that R² is not allylic. In some embodiments, R² is not allylic.

In various embodiments, the at least one first acrylate and/or methacrylate monomer represented by general formula (1) is selected from the group consisting of methyl acrylate, ethyl acrylate, n-propyl acrylate, isopropyl acrylate, n-butyl acrylate, t-butyl acrylate, isobutyl acrylate, pentyl acrylate, hexyl acrylate, n-amyl acrylate, isoamyl acrylate, heptyl acrylate, octyl acrylate, isooctyl acrylate, ethylhexyl acrylate, 2-ethylhexyl acrylate, vinyl acrylate, cycloalkyl acrylates such as cyclohexyl acrylate, methyl methacrylate, ethyl methacrylate, n-propyl methacrylate, isopropyl methacrylate, n-butyl methacrylate, t-butyl methacrylate, isobutyl methacrylate, pentyl methacrylate, hexyl methacrylate, n-amyl methacrylate, isoamyl methacrylate, heptyl methacrylate, octyl methacrylate, isooctyl methacrylate, ethylhexyl methacrylate, 2-ethylhexyl methacrylate, vinyl methacrylate, cycloalkyl methacrylates such as cyclohexyl methacrylate and combinations thereof.

In various embodiments, the mixture of monomers comprises the first acrylate and/or methacrylate monomer added in a concentration of from about 40.0 wt % to about 99.99 wt % with respect to the total weight of the monomers. The concentration of the first acrylate and/or methacrylate monomer may be from about 40.0 wt % to about 99.99 wt %, from about 41.0 wt % to about 99.95 wt %, from about 42.0 wt %, to about 99.9 wt %, from about 43.0 wt % to about 99.5 wt %, from about 44.0 wt % to about 99.0 wt %, from about 45.0 wt % to about 98.0 wt %, from about 46.0 wt % to about 97.0 wt %, from about 47.0 wt % to about 96.0 wt %, from about 48.0 wt % to about 95.0 wt %, from about 49.0 wt % to about 94.0 wt %, from about 50.0 wt % to about 93.0 wt %, from about 55.0 wt % to about 92.0 wt %, from about 60.0 wt % to about 91.0 wt %, from about 65.0 wt % to about 90.0 wt %, from about 70.0 wt % to about 89.0 wt %, from about 71.0 wt % to about 88.0 wt %, from about 72.0 wt % to about 87.0 wt %, from about 73.0 wt % to about 86.0 wt %, from about 74.0 wt % to about 85.0 wt %, from about 75.0 wt % to about 84.0 wt %, from about 76.0 wt % to about 83.0 wt %, from about 77.0 wt % to about 82.0 wt %, from about 78.0 wt % to about 81.0 wt %, from about 79.0 wt % to about 80.0 wt %, or about 79.5 wt % with respect to the total weight of the monomers. For example, the concentration of the first acrylate and/or methacrylate monomer may be from about 70.0 weight % to about 90.0 weight %, from about 70.0 weight % to about 85.0 weight %, or from about 70.0 weight % to about 80.0 weight % with respect to the total weight of the monomers.

In various embodiments, the first acrylate and/or methacrylate monomer is different from the second acrylate and/or methacrylate monomer. For example, the first acrylate and/or methacrylate monomer may be devoid or substantially devoid of hydrophilic groups.

In various embodiments, the at least one cyclic ketene acetal monomer is represented by general formula (2):

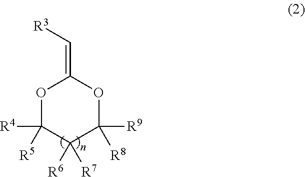

wherein
n is 0, 1, 2 or 3;
R³ is selected from H or optionally substituted linear or branched C₁-C₂₀ alkyl; and
R⁴ to R⁹ are each independently selected from H, optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof.

In various embodiments, the method comprises a step of reacting/polymerizing/copolymerizing at least one, at least two, at least three, at least four, at least five, at least six, at least seven, at least eight, at least nine, or at least ten cyclic ketene acetal monomers. In various embodiments, the step of reacting/polymerizing/copolymerizing the cyclic ketene acetal monomer comprise ring opening polymerisation (e.g., free radical ring opening polymerisation) of the cyclic ketene acetal monomers. In other words, the ring of the cyclic ketene acetal monomers may open during polymerization, e.g., to form ester group(s) in the backbone of the polymer.

In various embodiments, R³ to R⁹ are each independently selected from C₁-C₂₀ alkyl. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, 2-ethylhexyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. R³ to R⁹ may be straight or branched C₁-C₅ alkyl substituents.

The cyclic ketene acetal (CKA) monomer may comprise a 5-membered ring (i.e. 5-membered CKA; where n=0), 6-membered ring (i.e. 6-membered CKA; where n=1), 7-membered ring (i.e. 7-membered CKA; where n=2) or 8-membered ring (i.e. 8-membered CKA; where n=3). For example, the cyclic ketene acetal monomer may be selected from the group consisting of 2-methylene-1,3-dioxepane, 2-methylene-1,3-dioxocane, and combinations thereof.

In various embodiments, the mixture of monomers comprises the cyclic ketene acetal monomer added in a concentration of from about 0.01 wt % to about 60.0 wt % with respect to the total weight of the monomers. The concentration of the cyclic ketene acetal monomer may be from about 0.01 wt % to about 60.0 wt %, from about 0.05 wt % to about 55.0 wt %, from about 0.1 wt % to about 50.0 wt %, from about 0.5 wt % to about 45.0 wt %, from about 1.0 wt % to about 40.0 wt %, from about 2.0 wt % to about 39.0 wt %, from about 3.0 wt % to about 38.0 wt %, from about 4.0 wt % to about 37.0 wt %, from about 5.0 wt % to about 36.0 wt %, from about 6.0 wt % to about 35.0 wt %, from about 7.0 wt % to about 34.0 wt %, from about 8.0 wt % to about 33.0 wt %, from about 9.0 wt % to about 32.0 wt %, from about 10.0 wt % to about 31.0 wt %, from about 11.0 wt % to about 30.0 wt %, from about 12.0 wt % to about 29.0 wt %, from about 13.0 wt % to about 28.0 wt %, from about 14.0 wt % to about 27.0 wt %, from about 15.0 wt % to about 26.0 wt %, from about 16.0 wt % to about 25.0 wt %, from about 17.0 wt % to about 24.0 wt %, from about 18.0 wt % to about 23.0 wt %, from about 19.0 wt % to about 22.0 wt %, or from about 20.0 wt % to about 21.0 wt % with respect to the total weight of the monomers. For example, the concentration of the cyclic ketene acetal monomer may be from about 10.0 weight % to about 30.0 weight %, or from about 10.0 weight % to about 25.0 weight % with respect to the total weight of the monomers.

In various embodiments, the at least one additional monomer is functionalized with hydrophilic groups. In various embodiments, the at least one second acrylate and/or methacrylate monomer is functionalized with hydrophilic groups. In various embodiments, the at least one vinyl monomer is functionalized with hydrophilic groups. The hydrophilic groups may be selected from the group consisting of hydroxy, carbonyl, carboxyl, carboxylate, amine (e.g., amino or secondary amine), amide, cyclic amide (or lactam), sulfhydryl, sulfate, sulfonate, phosphate, carbonate, thiocarbonyl, thiocarboxyl, sulfinic, hydrazine, hydroxylamine and combinations thereof.

In various embodiments therefore, the at least one second acrylate and/or methacrylate monomer is a hydrophilic and/or a water-soluble monomer. In various embodiments therefore, the at least one vinyl monomer is a hydrophilic and/or a water-soluble monomer. In various embodiments, the hydrophilic monomer plays an important role in emulsion stabilization/polymerization. Advantageously, in various embodiments, polymer chains derived from the hydrophilic monomer plays a major/important role in stabilization. Without being bound by theory, it is believed that without the hydrophilic monomer, the emulsion particle may be unstable under the conditions used and coagulation may occur, leading to failure of the reaction (e.g., polymerization/emulsion polymerization).

In various embodiments, the at least one second acrylate and/or methacrylate monomer(s) that is/are functionalized with hydrophilic functional groups is represented by general formula (3):

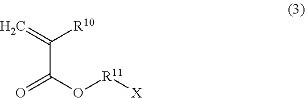

wherein
R¹⁰ is selected from H or methyl (CH₃);
R¹¹ is selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof; and X comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof.

In various embodiments, the method comprises a step of reacting/polymerizing/copolymerizing at least one, at least two, at least three, at least four, at least five, at least six, at least seven, at least eight, at least nine, or at least ten second acrylate and/or methacrylate monomers. The second acrylate and/or methacrylate monomers functionalized with hydrophilic functional groups may comprise all acrylate monomers (i.e. where R¹⁰=H), all methacrylate monomers (i.e. where R¹⁰=CH₃), or a mixture of both acrylate and methacrylate monomers (i.e. where R¹⁰=H and R¹⁰=CH₃). For example, the polymer obtained may be an acrylate copolymer (e.g., a copolymer comprising a single type or different types of acrylate monomers), a methacrylate copolymer (e.g., a copolymer comprising a single type or different types of methacrylate monomers), or an acrylate and methacrylate copolymer (e.g., a copolymer comprising both acrylate and methacrylate monomers).

In various embodiments, R¹¹ is selected from C₁-C₂₀ alkyl. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, 2-ethylhexyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. R¹¹ may be straight or branched C₁-C₅ alkyl substituents.

In various embodiments, X comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof. For example, X may comprise —OH, —C(═O)—, —C(═O)—O—R^{a}, —C(═O)—O— or —CO₂⁻, —NH₂, —NR^{a}R^{b}, —SH, —SR^{a}, —S(═O)₂—OH₂, —S(═O)₂—O₂— or —SO₄²—, —S(═O)₂—OH, —S(═O)₂—O— or —SO₃—, —P(═O)—OH₃, —P(═O)—O₃ or —PO₄³⁻, —C(═O)—O₂ or —CO₃²—, —C(═S)—, —C(═S)—OH, —C(═O)—SH, —S(═O)—OH, —NR^{a}—NR^{b}R^{c}, —NR^{a}OH or combinations thereof. In various embodiments, R^{a}, R^{b} and R^{c} are each independently selected from the group consisting of H, optionally substituted alkyl, optionally substituted alkenyl and optionally substituted alkynyl. R^{a}, R^{b} and R^{c} may be each independently selected from H or C₁-C₂₀ alkyl.

In various embodiments, the at least one second acrylate and/or methacrylate monomer represented by general formula (3) is an acrylate monomer functionalized with hydrophilic functional group (e.g., hydrophilic ethyl acrylate) or a methacrylate monomer functionalized with hydrophilic functional group (e.g., hydrophilic ethyl acrylate). For example, the at least one second acrylate and/or methacrylate monomer represented by general formula (3) may be selected from the group consisting of amino acrylates, 2-hydroxyethyl acrylate (HEA), hydroxyethyl methacrylate (HEMA), 2-(dimethylamino)ethyl acrylate (DMAEA), 2-(dimethylamino)ethyl methacrylate (DMAEMA) and combinations thereof.

In various embodiments, the at least one vinyl monomer(s) that is/are functionalized with hydrophilic functional groups is represented by general formula (7):

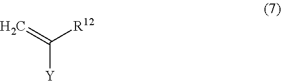

wherein
R¹² is selected from H, optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof; and
Y comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof.

In various embodiments, the method comprises a step of reacting/polymerizing/copolymerizing at least one, at least two, at least three, at least four, at least five, at least six, at least seven, at least eight, at least nine, or at least ten vinyl monomers.

In various embodiments, R¹² is selected from H or C₁-C₂₀ alkyl. The C₁-C₂₀ alkyl substituents may be straight or branched substituents selected from methyl, ethyl, n-propyl, 2-propyl, isopropyl, n-butyl, isobutyl, sec-butyl, t-butyl, hexyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl, 2-ethylpentyl, 3-ethylpentyl, 2-ethylhexyl, heptyl, 1-methylhexyl, 2,2-dimethylpentyl, 3,3-dimethylpentyl, 4,4-dimethylpentyl, 1,2-dimethylpentyl, 1,3-dimethylpentyl, 1,4-dimethylpentyl, 1,2,3-trimethylbutyl, 1,1,2-trimethylbutyl, 1,1,3-trimethylbutyl, 5-methylheptyl, 1-methylheptyl, octyl, nonyl, decyl or the like. R¹² may be straight or branched C₁-C₅ alkyl substituents.

In various embodiments, Y comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof. For example, Y may comprise —OH, —C(═O)—, —C(═O)—O—R^{a}, —C(═O)—O— or —C₀O₂—, —NH₂, —NR^{a}R^{b}, —SH, —SR^{a}, —S(═O)₂—OH₂, —S(═O)₂—O₂— or —SO₄²—, —S(═O)₂—OH, —S(═O)₂—O— or —SO₃—, —P(═O)—OH₃, —P(═O)—O₃ or —PO₄₃—, —C(═O)—O₂ or —CO₃²—, —C(═S)—, —C(═S)—OH, —C(═O)—SH, —S(═O)—OH, —NR^{a}—NR^{b}R^{c}, —NR^{a}OH or combinations thereof. In various embodiments, R^{a}, R^{b} and R^{c} are each independently selected from the group consisting of H, optionally substituted alkyl, optionally substituted alkenyl and optionally substituted alkynyl. R^{a}, R^{b} and R^{c} may be each independently selected from H or C₁-C₂₀ alkyl.

In various embodiments, Y comprises cyclic amide. In some embodiments, the cyclic amide comprises lactam (e.g., β-lactam, γ-lactam, δ-lactam, and ε-lactam). For example, the at least one vinyl monomer represented by general formula (7) may be vinyl pyrrolidone, N-vinylpyrrolidone, or the like.

In various embodiments, Y comprises sulfonate (e.g., sodium sulfonate or —SO₃⁻Na⁺), hydroxy (—OH) or combinations thereof. For example, the at least one vinyl monomer represented by general formula (7) may be sodium 1-allyloxy-2-hydroxypropyl sulfonate or the like.

In various embodiments, the mixture of monomers comprises the additional monomer (selected from the group consisting of a second acrylate and/or methacrylate monomer, a vinylic monomer and combinations thereof) added in a concentration of from about 0.01 wt % to about 50.0 wt % with respect to the total weight of the monomers. The concentration of the additional monomer (e.g., second acrylate and/or methacrylate monomer) may be from about 0.01 wt % to about 50.0 wt %, from about 0.05 wt % to about 47.5 wt %, from about 0.1 wt % to about 45.0 wt %, from about 0.5 wt % to about 42.5 wt %, from about 1.0 wt % to about 40.0 wt %, from about 2.0 wt % to about 39.0 wt %, from about 3.0 wt % to about 38.0 wt %, from about 4.0 wt % to about 37.0 wt %, from about 5.0 wt % to about 36.0 wt %, from about 6.0 wt % to about 35.0 wt %, from about 7.0 wt % to about 34.0 wt %, from about 8.0 wt % to about 33.0 wt %, from about 9.0 wt % to about 32.0 wt %, from about 10.0 wt % to about 31.0 wt %, from about 11.0 wt % to about 30.0 wt %, from about 12.0 wt % to about 29.0 wt %, from about 13.0 wt % to about 28.0 wt %, from about 14.0 wt % to about 27.0 wt %, from about 15.0 wt % to about 26.0 wt %, from about 16.0 wt % to about 25.0 wt %, from about 17.0 wt % to about 24.0 wt %, from about 18.0 wt % to about 23.0 wt %, from about 19.0 wt % to about 22.0 wt %, or from about 20.0 wt % to about 21.0 wt % with respect to the total weight of the monomers. For example, the concentration of the additional monomer (e.g., second acrylate and/or methacrylate monomer) may be from about 1.0 weight % to about 20.0 weight %, or about 5.0 weight % with respect to the total weight of the monomers.

In various embodiments, the at least one first acrylate and/or methacrylate monomer; at least one cyclic ketene acetal monomer(s); and at least one additional monomer(s) (selected from the group consisting of a second acrylate and/or methacrylate monomer(s) that is functionalized with hydrophilic groups, a vinylic monomer(s) that is functionalized with hydrophilic groups, and combinations thereof) are mixed in a mass ratio of about 10-20:about 2-6:about 0.01-2 or in a mass ratio of about 10-20:about 2-6:about 0.2-2.

In some embodiments, the at least one first acrylate and/or methacrylate monomer; at least one cyclic ketene acetal monomer(s); and at least one additional monomer(s) (selected from the group consisting of a second acrylate and/or methacrylate monomer(s) that is functionalized with hydrophilic groups, a vinylic monomer(s) that is functionalized with hydrophilic groups, and combinations thereof) is mixed in a mass ratio of about 12-18:2-5:0.5-1.5, about 14-17:2-5:1, about 17:2:1, about 14:5:1, or about 15:4:1. Advantageously, the composition of the monomer mixture may be adjusted/tunable/customized depending on the application the polymer is to be used for, thereby making the method disclosed herein a highly versatile method for polymer customization.

In various embodiments, the polymer prepared from embodiments of the method disclosed herein comprises a poly(acrylate) backbone, a poly(methacrylate) backbone, a poly(cyclic ketene acetal) backbone such as poly(cyclic ketene acetal derived ester) backbone, a poly(acrylate-co-cyclic ketene acetal) backbone such as poly(acrylate-co-cyclic ketene acetal derived ester) backbone, a poly(methacrylate-co-cyclic ketene acetal) backbone such as poly(methacrylate-co-cyclic ketene acetal derived ester) backbone, poly(acrylate-co-cyclic ketene acetal-co-methacrylate) backbone such as poly(acrylate-co-cyclic ketene acetal derived ester-co-methacrylate) backbone, a poly(methacrylate-co-cyclic ketene acetal-co-methacrylate) backbone such as poly(methacrylate-co-cyclic ketene acetal derived ester-co-methacrylate) backbone, poly(acrylate-co-cyclic ketene acetal-co-acrylate) backbone such as poly(acrylate-co-cyclic ketene acetal derived ester-co-acrylate) backbone, a poly(acrylate)-co-poly(cyclic ketene acetal) backbone such as poly(acrylate)-co-poly(cyclic ketene acetal derived ester) backbone (e.g., poly(acrylate)-co-poly(MDO) backbone) and/or a poly(methacrylate)-co-poly(cyclic ketene acetal) backbone such as poly(methacrylate)-co-poly(cyclic ketene acetal derived ester) backbone (e.g., poly(methacrylate)-co-poly(MDO) backbone). It will be appreciated that a poly(cyclic ketene acetal) is different from and can be distinguished from a polyacetal (which is devoid of an ester group). Accordingly, the polymer prepared from embodiments of the method disclosed herein is different from those of the art which yield a polymer comprising a polyacetal (or polyacetal backbone).

The polymer may be an acrylate and/or methacrylate copolymer. For example, the polymer may be an acrylate copolymer (e.g., an emulsion copolymer comprising acrylate), a methacrylate copolymer (e.g., an emulsion copolymer comprising methacrylate), or an acrylate and methacrylate copolymer (e.g., an emulsion copolymer comprising both acrylate and methacrylate).

In various embodiments, the polymer comprises at least one unit of the following structural sequence A-B-C, where A comprises cyclic ketene acetal monomer derived ester group, and where B and C comprise different acrylate and/or methacrylate monomer derived units having hydrophilic and/or hydrophobic groups randomly arranged along the sequence. In various embodiments, A comprises a structural unit derived from the cyclic ketene acetal monomer, B comprises a structural unit derived from the first acrylate and/or methacrylate monomer, and C comprises a structural unit derived from the additional monomer (selected from the group consisting of a second acrylate and/or methacrylate monomer that is functionalized with hydrophilic groups, a vinylic monomer that is functionalized with hydrophilic groups, and combinations thereof). It may be appreciated that in various embodiments, the positions of A, B and C may be interchanged among themselves.

The structural sequence A-B—C units may be randomly distributed in/along the polymer chain to form sequences that are rich in any of the aforementioned components (i.e. A, B and C). In various embodiments, A is occasionally/sporadically/infrequently distributed in/along the polymer chain. For example, the amount of A present in/along the polymer chain may be lower/higher than the amount of B and/or C present in/along the polymer chain. Advantageously, such a design/structure of the polymer allows embodiments of the polymer to form/degrade/break down into oligomer(s), monomer(s) and/or smaller molecule(s) (e.g., different types of oligomers) upon hydrolysis or environmental degradation of the polymer (e.g., polymer latex).

In various embodiments, the polymer prepared from embodiments of the method disclosed herein comprises one or more repeating/structural units represented general formula (4); one or more repeating/structural units represented by general formula (5); and one or more repeating/structural units represented by general formula (6) and/or general formula (8):

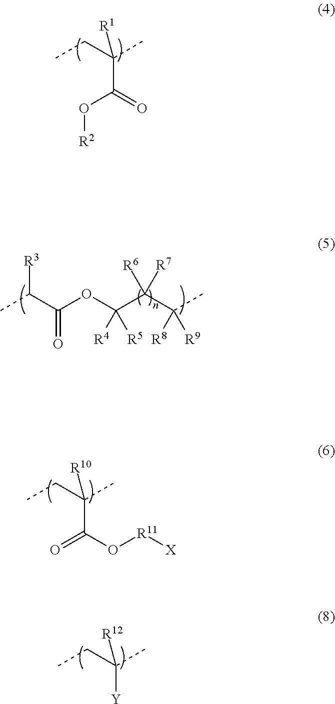

In various embodiments, the dashed line represents a chemical bond attaching one repeating/structural unit to another one repeating/structural unit. For example, repeating unit represented by general formula (5) which contains two dashed lines may be bonded to a repeating unit represented by general formula (6) at one end and bonded to a repeating unit represented by general formula (4) at another end (e.g., in the following structural sequence (6)-(5)-(4)). General formula (4) also may be bonded to general formula (4), general formula (5), general formula (6) and/or general formula (8); general formula (5) may be bonded to general formula (4), general formula (5), general formula (6) and/or general formula (8); and general formula (6) may be bonded to general formula (4), general formula (5), general formula (6) and/or general formula (8).

In various embodiments, the repeating units represented by general formula (4), (5) and (6) are bonded in a structural sequence that is randomly distributed in/along the polymer chain. The repeating units represented by general formula (4), (5) and (6) may be each occasionally/sporadically/infrequently distributed in/along the polymer chain. For example, the repeating units represented by general formula (4), (5) and (6) may be bonded as shown in the following structural sequence (4)-(5)-(6):

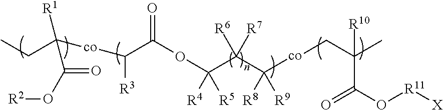

In various embodiments, R¹ to R¹², X, Y and n contain one or more features and/or share one or more properties that are similar to those described above.

In various embodiments, the polymer comprises a plurality of ester groups. The ester groups may be present in both the backbone and in the pendant/side groups (or pendant/side chains) of the polymer.

In various embodiments, the polymer comprises a plurality of ester groups in the pendant/side groups of the polymer. In various embodiments, the ester groups present in the pendant/side groups of the polymer are attributed to the presence of repeating units represented by general formula (4) and/or general formula (6). Accordingly, the ester groups present in the pendant/side groups of the polymer (or repeating units represented by general formula (4) and/or general formula (6)) may be derived from the first and/or second acrylate and/or methacrylate monomers (or monomers represented by general formula (1) and/or general formula (3) respectively).

In various embodiments, the polymer comprises a plurality of ester groups in the backbone of the polymer. In various embodiments, the ester groups present in the backbone of the polymer are attributed to the presence of repeating units represented by general formula (5). Accordingly, the ester groups present in the backbone of the polymer (or repeating units represented by general formula (5)) may be derived from the cyclic ketene acetal monomers (or monomers represented by general formula (2)). Advantageously, the presence of the ester groups (or particularly, a plurality of ester groups) in the backbone of the polymer allows embodiments of the polymer to form/degrade/break down into oligomer(s), monomer(s) and/or smaller molecule(s) (e.g., different types of oligomers) upon hydrolysis or environmental degradation of the polymer. In various embodiments, the degradation of the polymer comprises cleavage of ester bonds present in the backbone of the polymer, thereby generating oligomer(s), monomer(s) and/or smaller molecule(s) with decreased/smaller/lower molar mass.

In various embodiments, the step of reacting/polymerizing/copolymerizing comprises incorporating at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about 25.0 mol %, at least about 30.0 mol %, at least about 35.0 mol %, at least about 40.0 mol %, at least about 41.0 mol %, at least about 42.0 mol %, at least about 43.0 mol %, at least about 44.0 mol %, at least about 45.0 mol %, at least about 46.0 mol %, at least about 47.0 mol %, at least about 48.0 mol %, at least about 49.0 mol %, at least about 50.0 mol %, at least about 51.0 mol %, at least about 52.0 mol %, at least about 53.0 mol %, at least about 54.0 mol %, at least about 55.0 mol %, at least about 56.0 mol %, at least about 57.0 mol %, at least about 58.0 mol %, at least about 59.0 mol %, or at least about 60.0 mol % of at least one cyclic ketene acetal monomer in the polymer. In other words, in various embodiments, at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about 25.0 mol %, at least about 30.0 mol %, at least about 35.0 mol %, at least about 40.0 mol %, at least about 41.0 mol %, at least about 42.0 mol %, at least about 43.0 mol %, at least about 44.0 mol %, at least about 45.0 mol %, at least about 46.0 mol %, at least about 47.0 mol %, at least about 48.0 mol %, at least about 49.0 mol %, at least about 50.0 mol %, at least about 51.0 mol %, at least about 52.0 mol %, at least about 53.0 mol %, at least about 54.0 mol %, at least about 55.0 mol %, at least about 56.0 mol %, at least about 57.0 mol %, at least about 58.0 mol %, at least about 59.0 mol %, or at least about 60.0 mol % of the total amount/concentration of ester groups present in the polymer are derived from the cyclic ketene acetal monomers.

In various embodiments, the step of reacting/polymerizing/copolymerizing comprises incorporating at least about 40.0 mol %, at least about 41.0 mol %, at least about 42.0 mol %, at least about 43.0 mol %, at least about 44.0 mol %, at least about 45.0 mol %, at least about 46.0 mol %, at least about 47.0 mol %, at least about 48.0 mol %, at least about 49.0 mol %, at least about 50.0 mol %, at least about 51.0 mol %, at least about 52.0 mol %, at least about 53.0 mol %, at least about 54.0 mol %, at least about 55.0 mol %, at least about 56.0 mol %, at least about 57.0 mol %, at least about 58.0 mol %, at least about 59.0 mol %, at least about 60.0 mol %, at least about 65.0 mol %, at least about 70.0 mol %, at least about 75.0 mol %, at least about 80.0 mol %, at least about 85.0 mol %, at least about 90.0 mol %, at least about 91.0 mol %, at least about 92.0 mol %, at least about 93.0 mol %, at least about 94.0 mol %, at least about 95.0 mol %, at least about 96.0 mol %, at least about 97.0 mol %, at least about 98.0 mol %, at least about 99.0 mol %, at least about 99.5 mol %, at least about 99.9 mol %, at least about 99.95 mol %, or at least about 99.99 mol % of at least one first acrylate and/or methacrylate monomer in the polymer. In other words, in various embodiments, at least about 40.0 mol %, at least about 41.0 mol %, at least about 42.0 mol %, at least about 43.0 mol %, at least about 44.0 mol %, at least about 45.0 mol %, at least about 46.0 mol %, at least about 47.0 mol %, at least about 48.0 mol %, at least about 49.0 mol %, at least about 50.0 mol %, at least about 51.0 mol %, at least about 52.0 mol %, at least about 53.0 mol %, at least about 54.0 mol %, at least about 55.0 mol %, at least about 56.0 mol %, at least about 57.0 mol %, at least about 58.0 mol %, at least about 59.0 mol %, at least about 60.0 mol %, at least about 65.0 mol %, at least about 70.0 mol %, at least about 75.0 mol %, at least about 80.0 mol %, at least about 85.0 mol %, at least about 90.0 mol %, at least about 91.0 mol %, at least about 92.0 mol %, at least about 93.0 mol %, at least about 94.0 mol %, at least about 95.0 mol %, at least about 96.0 mol %, at least about 97.0 mol %, at least about 98.0 mol %, at least about 99.0 mol %, at least about 99.5 mol %, at least about 99.9 mol %, at least about 99.95 mol %, or at least about 99.99 mol % of the total amount/concentration of ester groups present in the polymer are derived from the first acrylate and/or methacrylate monomers.

In various embodiments, the step of reacting/polymerizing/copolymerizing comprises incorporating at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about at least about 25.0 mol %, at least about 30.0 mol %, at least about 35.0 mol %, at least about 40.0 mol %, at least about 45.0 mol %, or at least about 50.0 mol % of at least one additional monomer (e.g., second acrylate and/or methacrylate monomer) in the polymer. In other words, in various embodiments, at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about at least about 25.0 mol %, at least about 30.0 mol %, at least about 35.0 mol %, at least about 40.0 mol %, at least about 45.0 mol %, or at least about 50.0 mol % of the total amount/concentration of ester groups present in the polymer are derived from the additional monomers (e.g., second acrylate and/or methacrylate monomers).

Advantageously, embodiments of the method disclosed herein obtain excellent/high reaction conversion for the monomers. In various embodiments, the reaction conversion for the first acrylate and/or methacrylate monomer is at least about 80%, at least about 85%, at least about 90%, at least about 95%, at least about 98%, at least about 99%, or at least about 100%. In various embodiments, the reaction conversion for the additional monomer (e.g., second acrylate and/or methacrylate monomer) is at least about 80%, at least about 85%, at least about 90%, at least about 95%, at least about 98%, at least about 99%, or at least about 100%. In various embodiments, the reaction conversion for the cyclic ketene acetal monomer is at least about 80%, at least about 85%, at least about 90%, at least about 95%, at least about 98%, at least about 99%, or at least about 100%.

The amount of general formula (5) (e.g., derived from cyclic ketene acetal monomers) present in/along the polymer chain may be lower/higher than the amount of general formula (4) (e.g., derived from first acrylate and/or methacrylate monomers), general formula (6) (e.g., derived from second acrylate and/or methacrylate monomers) and/or general formula (8) (e.g., derived from vinylic monomers) present in/along the polymer chain. In various embodiments, the ratio of the total number of repeating/structural units represented by general formula (4), general formula (6) and/or general formula (8) to the total number of repeating/structural units represented by general formula (5) in the polymer is about 0.40 to 0.99:0.01 to 0.60. The ratio of the total number of repeating/structural units represented by general formula (4), general formula (6) and/or general formula (8) to the total number of repeating/structural units represented by general formula (5) in the polymer may be about 0.50 to 0.99: 0.01 to 0.50, about 0.60 to 0.99:0.01 to 0.40, about 0.70 to 0.99:0.01 to 0.30, about 0.80 to 0.99:0.01 to 0.20, or about 0.91 to 0.97:0.03 to 0.09.

In various embodiments, the incorporation of the cyclic ketene acetal monomers in the polymer (or particularly, in the backbone of the polymer) is from about 0.01 mol % to about 60.0 mol %. Accordingly, in various embodiments, the polymer comprises at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about 25.0 mol %, at least about 30.0 mol %, at least about 35.0 mol %, at least about 40.0 mol %, at least about 41.0 mol %, at least about 42.0 mol %, at least about 43.0 mol %, at least about 44.0 mol %, at least about 45.0 mol %, at least about 46.0 mol %, at least about 47.0 mol %, at least about 48.0 mol %, at least about 49.0 mol %, at least about 50.0 mol %, at least about 51.0 mol %, at least about 52.0 mol %, at least about 53.0 mol %, at least about 54.0 mol %, at least about 55.0 mol %, at least about 56.0 mol %, at least about 57.0 mol %, at least about 58.0 mol %, at least about 59.0 mol %, or at least about 60.0 mol % of repeating units represented by general formula (5) (i.e. derived from cyclic ketene acetal monomers) in the polymer.

In various embodiments, the incorporation of the first acrylate and/or methacrylate monomers (or repeating units represented by general formula (4)) in the polymer (or particularly, in the pendant/side groups of the polymer) is from about 40.0 mol % to about 99.9 mol %. Accordingly, in various embodiments, the polymer comprises at least about 40.0 mol %, at least about 41.0 mol %, at least about 42.0 mol %, at least about 43.0 mol %, at least about 44.0 mol %, at least about 45.0 mol %, at least about 46.0 mol %, at least about 47.0 mol %, at least about 48.0 mol %, at least about 49.0 mol %, at least about 50.0 mol %, at least about 51.0 mol %, at least about 52.0 mol %, at least about 53.0 mol %, at least about 54.0 mol %, at least about 55.0 mol %, at least about 56.0 mol %, at least about 57.0 mol %, at least about 58.0 mol %, at least about 59.0 mol %, at least about 60.0 mol %, at least about 65.0 mol %, at least about 70.0 mol %, at least about 75.0 mol %, at least about 80.0 mol %, at least about 85.0 mol %, at least about 90.0 mol %, at least about 91.0 mol %, at least about 92.0 mol %, at least about 93.0 mol %, at least about 94.0 mol %, at least about 95.0 mol %, at least about 96.0 mol %, at least about 97.0 mol %, at least about 98.0 mol %, at least about 99.0 mol %, at least about 99.5 mol %, at least about 99.9 mol %, at least about 99.95 mol %, or at least about 99.99 mol % of repeating units represented by general formula (4) (i.e. derived from first acrylate and/or methacrylate monomers) in the polymer.

In various embodiments, the incorporation of the second acrylate and/or methacrylate monomers (or repeating units represented by general formula (6)) and/or the incorporation of the vinylic monomers (or repeating units represented by general formula (8)) in the polymer (or particularly, in the pendant/side groups of the polymer) is from about 0.01 mol % to about 50.0 mol %. Accordingly, in various embodiments, the polymer comprises at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about at least about 25.0 mol %, at least about 30.0 mol %, at least about 35.0 mol %, at least about 40.0 mol %, at least about 45.0 mol %, or at least about 50.0 mol % of at least one additional monomer (selected from the group consisting of a second acrylate and/or methacrylate monomer, a vinylic monomer and combinations thereof) in the polymer. In other words, in various embodiments, at least about 0.01 mol %, at least about 0.05 mol %, at least about 0.1 mol %, at least about 0.5 mol %, at least about 1.0 mol %, at least about 2.0 mol %, at least about 3.0 mol %, at least about 4.0 mol %, at least about 5.0 mol %, at least about 6.0 mol %, at least about 7.0 mol %, at least about 8.0 mol %, at least about 9.0 mol %, at least about 10.0 mol %, at least about 15.0 mol %, at least about 20.0 mol %, at least about at least about 25.0 mol %, at least about 30.0 mol %, at least about 35.0 mol %, at least about 40.0 mol %, at least about 45.0 mol %, or at least about 50.0 mol % of repeating units represented by general formula (6) (i.e. derived from second acrylate and/or methacrylate monomers) and/or repeating units represented by general formula (8) (i.e. derived from vinylic monomers) in the polymer.

In various embodiments, the polymer has a number average molecular weight (Mn) of from about 10,000 to about 1,000,000, from about 15,000 to about 950,000, from about 20,000 to about 900,000, from about 25,000 to about 850,000, from about 30,000 to about 800,000, from about 35,000 to about 750,000, from about 40,000 to about 700,000, from about 45,000 to about 650,000, from about 50,000 to about 600,000, from about 55,000 to about 550,000, from about 60,000 to about 500,000, from about 65,000 to about 450,000, from about 70,000 to about 400,000, from about 75,000 to about 350,000, from about 80,000 to about 300,000, from about 85,000 to about 250,000, from about 90,000 to about 200,000, from about 95,000 to about 150,000, or about 100,000. It will be appreciated that the number average molecular weight (Mn) of the polymer may be adjustable/tunable/customizable, depending on the application the polymer is to be used for.

In various embodiments, the polymer has a weight average molecular weight (Mw) of from about 100,000 to about 600,000, from about 150,000 to about 550,000, from about 200,000 to about 500,000, from about 250,000 to about 450,000, from about 300,000 to about 400,000, or about 350,000.

In various embodiments, the polymer has a peak molecular weight (Mp) of from about 50,000 to about 500,000, from about 100,000 to about 450,000, from about 150,000 to about 400,000, from about 200,000 to about 350,000, or from about 250,000 to about 300,000.

In various embodiments, the polymer undergoes cleavage/degradation (at the ester bonds/groups in the backbone of the polymer) into simpler forms, e.g., into oligomer(s), monomer(s) and/or smaller molecule(s) having an average molecular weight (Mn) of no more than about 10,000. For example, the resulting oligomer(s), monomer(s) and/or smaller molecule(s) obtained after degradation of the polymer has a number average molecular weight (Mn) of no more than about 10,000, no more than about 9,000, no more than about 8,000, no more than about 7,000, no more than about 6,000, no more than about 5,000, no more than about 4,000, no more than about 3,000, no more than about 2,000, no more than about 1,000, no more than about 900, no more than about 800, no more than about 700, no more than about 600, no more than about 500, no more than about 400, no more than about 300, no more than about 200, or no more than about 100. For example, the resulting oligomer(s), monomer(s) and/or smaller molecule(s) obtained after degradation of the polymer has a weight average molecular weight (Mw) of no more than about 20,000, no more than about 15,000, no more than about 14,000, no more than about 13,000, no more than about 12,000, no more than about 11,000, no more than about 10,000, no more than about 9,000, no more than about 8,000, no more than about 7,000, no more than about 6,000, no more than about 5,000, no more than about 4,000, no more than about 3,000, no more than about 2,000, no more than about 1,000, no more than about 900, no more than about 800, no more than about 700, no more than about 600, no more than about 500, no more than about 400, no more than about 300, no more than about 200, or no more than about 100. For example, the resulting oligomer(s), monomer(s) and/or smaller molecule(s) obtained after degradation of the polymer has a peak molecular weight (Mp) of no more than about 10,000, no more than about 9,000, no more than about 8,000, no more than about 7,000, no more than about 6,000, no more than about 5,000, no more than about 4,000, no more than about 3,000, no more than about 2,000, no more than about 1,000, no more than about 900, no more than about 800, no more than about 700, no more than about 600, no more than about 500, no more than about 400, no more than about 300, no more than about 200, or no more than about 100.

In various embodiments, the polymer prepared from embodiments of the method disclosed herein comprises one or more of the following characteristics or properties: non-toxic, hypoallergenic, biocompatible, degradable (e.g., hydrolytically degradable), biodegradable, environmentally benign, chemically stable and physically stable. Therefore, in various embodiments, the polymer may be useful in an application selected from the group consisting of: personal or consumer care applications, cosmetics, paper films, architectural paints, durable coatings, waterborne coatings, adhesives, foams, binders, floor, polish, inks, anti-edge wicking products, packaging, barrier coatings, gloves, biomedical, drug delivery systems, plastics, nanocomposites, drug carriers, scale control agents and combinations thereof. In various embodiments, the polymer may be modified to carry a wide variety of surface functionalities for further surface modifications and/or encapsulation (e.g., encapsulate different kind of materials such as drugs, dyes, inorganic materials etc).

### BRIEF DESCRIPTION OF FIGURES

FIG. 1 is a schematic diagram 100 showing a method for preparing a polymer (e.g., degradable polymer) having ester functionality in accordance with various embodiments disclosed herein.

FIG. 2 is a schematic diagram 200 showing a method for preparing poly(methyl methacrylate) (e.g., degradable poly(methyl methacrylate) nanoparticles) in accordance with various embodiments disclosed herein.

FIG. 3 shows ¹H NMR (CDCl₃) spectrum/analysis of polymer EM2 (after purification) in accordance with various embodiments disclosed herein.

FIG. 4 shows ¹H NMR (CDCl₃) spectrum/analysis of polymer EM3 (after purification) in accordance with various embodiments disclosed herein.

FIG. 5 is a calibration curve showing GPC analysis of polymerization and hydrolytic degradation of poly(MDO-co-MMA-co-HEA) copolymers before and after degradation in accordance with various embodiments disclosed herein.

FIG. 6 shows ¹H NMR (CDCl₃) spectrum/analysis of polymer EM5 and its oligomeric degradation products (after purification) in accordance with various embodiments disclosed herein.

FIG. 7 shows ¹³C NMR (CDCl₃) spectrum/analysis of polymer EM5 and its oligomeric degradation products (after purification) in accordance with various embodiments disclosed herein.

FIG. 8 shows SEM images obtained for polymers EM3, EM4 and EM7 in accordance with various embodiments disclosed herein.

FIG. 9 shows TEM images obtained for polymers EM4 and EM7 in accordance with various embodiments disclosed herein.

FIG. 10 is a calibration curve showing GPC analysis of polymerization and hydrolytic degradation of various copolymers (i.e. 3BA1MDO, 3EA1MDO, 3MA1MDO and 1MMA3BA20MDO) before and after degradation in accordance with various embodiments disclosed herein.

FIG. 11 is a calibration curve showing GPC analysis of polymerization and hydrolytic degradation of various copolymers (i.e. 1MMA3BA10MDO, 3BA1MDO 5DMAEMA, 3BMA1MDO and 1BA2BMA1MDO) before and after degradation in accordance with various embodiments disclosed herein.

### EXAMPLES

Example embodiments of the disclosure will be better understood and readily apparent to one of ordinary skill in the art from the following examples, tables and if applicable, in conjunction with the figures. It should be appreciated that other modifications related to structural, biological and/or chemical changes may be made without deviating from the scope of the invention. Example embodiments are not necessarily mutually exclusive as some may be combined with one or more embodiments to form new example embodiments. The example embodiments should not be construed as limiting the scope of the disclosure.

The following examples describe emulsion polymerizations being successfully carried out using acrylate and/or methacrylate monomers with cyclic ketene acetal (CKA) monomers in aqueous medium to produce a polymer that is degradable/biodegradable. To the best of the inventors' knowledge, such a successful emulsion polymerization has not been previously reported before.

The inventors have shown herein that it is possible to perform a copolymerization (e.g., emulsion copolymerization) using a simple and straightforward method via careful control of pH with a suitable identity of the surfactant etc. It will be shown in the following examples that a combination of high pH and presence of a neutral surfactant could effectively and successfully incorporate cyclic ketene acetal derived ester functionality into an emulsion polymer latex with high yield and incorporation rate to provide a degradable latex.

To the best of the inventors' knowledge, polymerization (or particularly emulsion polymerization) using cyclic ketene acetal monomers with methacrylate and/or acrylate monomers in aqueous media has not been previously described since it is not expected for cyclic ketene acetal monomers to withstand reactions in water. It will be appreciated that cyclic ketene acetal monomers inherently lack stability in water and generally undergoes hydrolysis under acidic, neutral and basic conditions in water.

### Example 1: Reaction Scheme and Preparation of Polymer

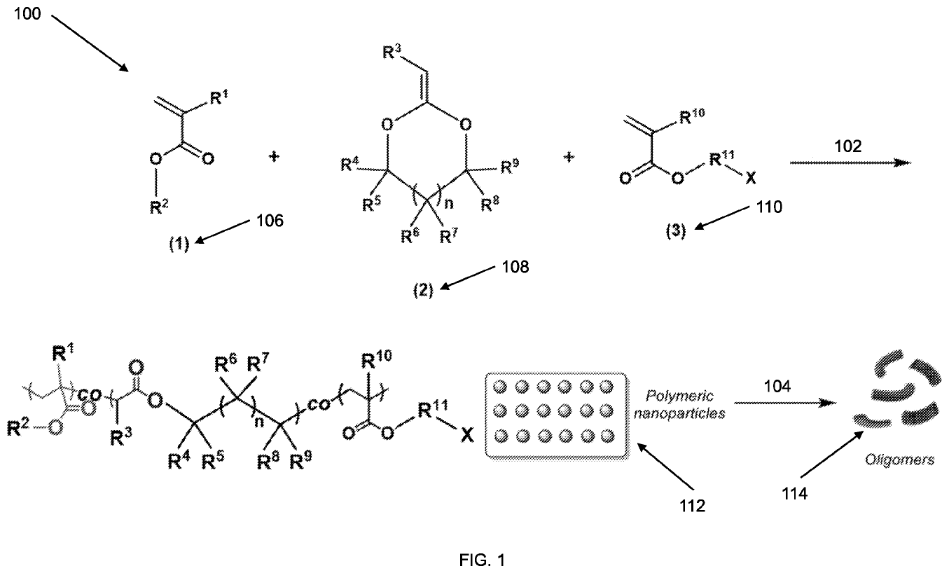

A method for preparing a polymer (e.g., degradable polymer) having ester functionality in accordance with various embodiments disclosed herein is shown in FIG. 1. In step 102, a mixture of monomers that comprises at least one first acrylate and/or methacrylate monomer 106; at least one cyclic ketene acetal monomers 108; and at least one additional monomer (e.g., second acrylate and/or methacrylate monomer that is functionalized with hydrophilic groups) 110 are reacted/polymerized/copolymerized to obtain a polymer having ester functionality in the backbone of the polymer (e.g., polymeric nanoparticles). The first acrylate and/or methacrylate monomer 106 is represented by general formula (1); the cyclic ketene acetal monomers 108 is represented by general formula (2); and the additional monomers (e.g., second acrylate and/or methacrylate monomer that is functionalized with hydrophilic groups) 110 is represented by general formula (3). An example of a repeating unit of the polymer having ester functionality in the backbone of the polymer (e.g., polymeric nanoparticles) is represented by 112 as shown in FIG. 1. The polymer (e.g., polymeric nanoparticles) is degradable/cleavable and can undergo degradation (e.g., hydrolytic degradation) at step 104 to form oligomers 114.

The following examples 1 to 6 use methyl methacrylate as an example of a first acrylate and/or methacrylate monomer; 2-methylene-1,3-dioxepane as an example of a cyclic ketene acetal monomer; and 2-hydroxyethyl acrylate as an example of a second acrylate and/or methacrylate monomer that is functionalized with hydrophilic groups.

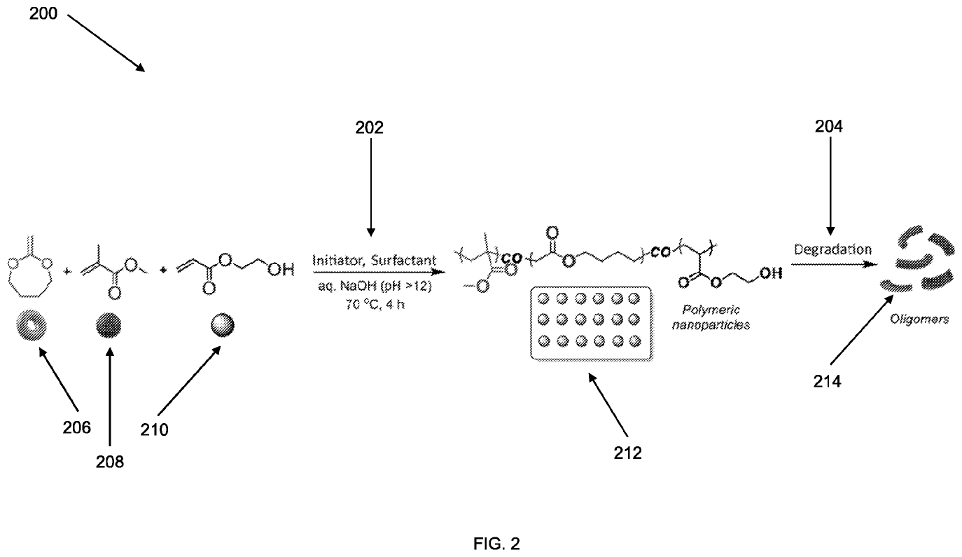

Degradable poly(methyl methacrylate) nanoparticles are synthesized via the copolymerization of methyl methacrylate (MMA) with 2-methylene-1,3-dioxepane (MDO) and 2-hydroxyethyl acrylate (HEA) in a ratio of about 75:20:5 respectively. Subsequent hydrolytic degradation of polymer affords oligomeric degradable products which helps to calculate mol % of degradable units in the main-chain polymer backbone (FIG. 2).

A method for preparing poly(methyl methacrylate) (e.g., degradable poly(methyl methacrylate) nanoparticles) in accordance with various embodiments disclosed herein is shown in FIG. 2. In step 202, a mixture of monomers that comprises at least one first acrylate and/or methacrylate monomer (e.g., methyl methacrylate (MMA) 208); at least one cyclic ketene acetal monomers (e.g., 2-methylene-1,3-dioxepane (MDO) 206); and at least one additional monomer (e.g., second acrylate and/or methacrylate monomer that is functionalized with hydrophilic groups such as 2-hydroxyethyl acrylate (HEA) 210) are reacted/polymerized/copolymerized to obtain degradable poly(methyl methacrylate) (e.g., poly(methyl methacrylate) nanoparticles) via emulsion polymerization.

Step 202 may be carried out in the presence of an initiator, a surfactant, a base (e.g., NaOH) at an alkaline/basic pH (e.g., pH >12). Step 202 may be carried out with heating at a temperature of about 70° C. over a duration of about 4 hours.

An example of a repeating unit of poly(methyl methacrylate) (e.g., poly(methyl methacrylate) nanoparticles) is represented by 212 as shown in FIG. 2. The main-chain poly(methyl methacrylate) (e.g., poly(methyl methacrylate) nanoparticles) is degradable/cleavable and can undergo degradation (e.g., hydrolytic degradation) at step 204 to form oligomers 214.

### Example 2: Reaction Conditions

Copolymerization of methylacrylates and cyclic ketene acetals is an interesting class of free radical ring-opening copolymerization that leads to high value-added biomaterials since degradable units are incorporated into the acrylate backbone to yield degradable acrylate copolymers in a single-step.

Copolymerizations were investigated initially by modifying mini emulsion conditions and the results are summarized in Table 1.

Performing 1:1 ratio of MMA and MDO with AIBN (azobisisobutyronitrile) as radical source, hexadecane as a co-stabilizer and mixture of SDS and Triton X-100 as surfactants and by applying ultra-sonication at 30 W for 30 sec in water before heating to 50° C. for 18 h under argon, resulted in only poly(methyl methacrylate) and MDO hydrolyzed product (Mini E-1). Introducing 2 wt % of ethylene glycol dimethacrylate (EGDMA) as cross linker with equal or lower loading of MDO corresponding to MMA loading, V-65 as initiator, either with poly(MMA-co-MDO) or PCL as co-stabilizers and SDS as surfactant gave either none or very low amount of poly(MDO-co-MMA) (Mini E-2 and Mini E-3). The progress of these reactions was monitored by ¹H NMR analysis.

The polymerization conditions as shown in Table 1 were then tuned by substituting with other stabilizer, initiator, surfactant type, pH of the reaction medium, reaction temperature and time. The obtained results are summarized in Table 2.

TABLE 1
Screening reaction conditions for the synthesis and
characterization of poly(MDO-co-MMA) copolymers

| | | | | | MDO |
|---|---|---|---|---|---|
| | | | | | incorpo- |
| Exper- | | Initi- | Co- | | ration |
| iment | MMA:MDO:EGDMA | ator | stabilizer | Conditions | (%)^{a} |
| Mini | 50:50:0 | AIBN | Hexa- | SDS (0.05 g), | —^{b} |
| E-1 | | (0.2 g) | decane | Triton X-100 | |
| | | | (0.12 g) | (0.05 g), | |
| | | | | NaHCO₃ (0.2 g), | |
| | | | | H₂O (25 g), | |
| | | | | 50° C., 18 h | |
| Mini | 49:49:2 | V-65 | Poly(MMA- | SDS (0.1 g), | —^{c} |
| E-2 | | (0.1 g) | c-MDO) | NaHCO₃ (0.1 g), | |
| | | | (0.1 g) | H₂O (20 g), | |
| | | | | 50° C., 18 h | |
| Mini | 73.5:24.5:2 | V-65 | PCL | SDS (0.1 g), | <1 |
| E-3 | | (0.1 g) | (0.1 g) | NaHCO₃ (0.1 g), | |
| | | | | H₂O (20 g), | |
| | | | | 50° C., 18 h | |

^{a}Determined by ¹H NMR analysis.
^{b}Observed only MDO hydrolyzed product.
^{c}Observed very little amount of MDO incorporation in polymer backbone (<1%) but assumed that it could be from a co-stabilizer used in the reaction medium.

TABLE 2
Optimization of reaction conditions for the synthesis and
characterization of poly(MDO-co-MMA) copolymers (EM1-EM9)

| | | | | MDO |
|---|---|---|---|---|
| | | | | incorpo- |
| Exper- | | Initi- | | ration |
| iment | MMA:MDO:HEA | ator | Conditions | (%)^{a} |
| EM1 | 80:20:0 | APS | SDS (0.125 g), TBAB (0.2 g), H₂O | —^{b} |
| | | | (20 g), aq. NaOH (pH >12), 70° C., | |
| | | | 4 h | |
| EM2 | 75:20:5 | APS | SDS (0.125 g), TBAB (0.2 g), H₂O | —^{b} |
| | | | (20 g), aq. NaOH (pH >12), 70° C., | |
| | | | 4 h | |
| EM3 | 75:20:5 | APS | Triton X-100 (0.125 g), TBAB | 3 |
| | | | (0.2 g), H₂O (20 g), aq. NaOH | |
| | | | (pH >12), 70° C., 4 h | |
| EM4 | 75:20:5 | APS | Triton X-100 (0.125 g), H₂O (20 g), | 9 |
| | | | aq. NaOH (pH >12), 70° C., 4 h | |
| EM5^{c} | 75:20:5 | APS | Triton X-100 (0.125 g), H₂O (20 g), | 7 |
| | | | aq. NaOH (pH >12), 70° C., 4 h | |
| EM6^{d} | 75:20:5 | APS | Triton X-100 (0.125 g), H₂O (20 g), | 7 |
| | | | aq. NaOH (pH >12), 70° C., 4 h | |
| EM7 | 75:20:5 | APS | Poloxamer-186 (0.125 g), H₂O | 6 |
| | | | (20 g), aq. NaOH (pH >12), 70° C., | |
| | | | 4 h | |
| EM8 | 80:20:0 | APS | Triton X-100 (0.125 g), H₂O (20 g), | <1 |
| | | | aq. NaOH (pH >12), 70° C., 4 h | |
| EM9^{e} | 75:20:5 | APS | PEG-b-PCL (0.125 g), H₂O (20 g), | 6 |
| | | | aq. NaOH (pH >12), 70° C., 4 h | |

^{a}Determined by ¹H NMR analysis.
^{b}Observed only PMMA and MDO hydrolyzed product.
^{c}Repeated EM4 reaction to check the reproducibility.
^{d}Used HEMA in place of HEA.
^{e}Found very low solid content.

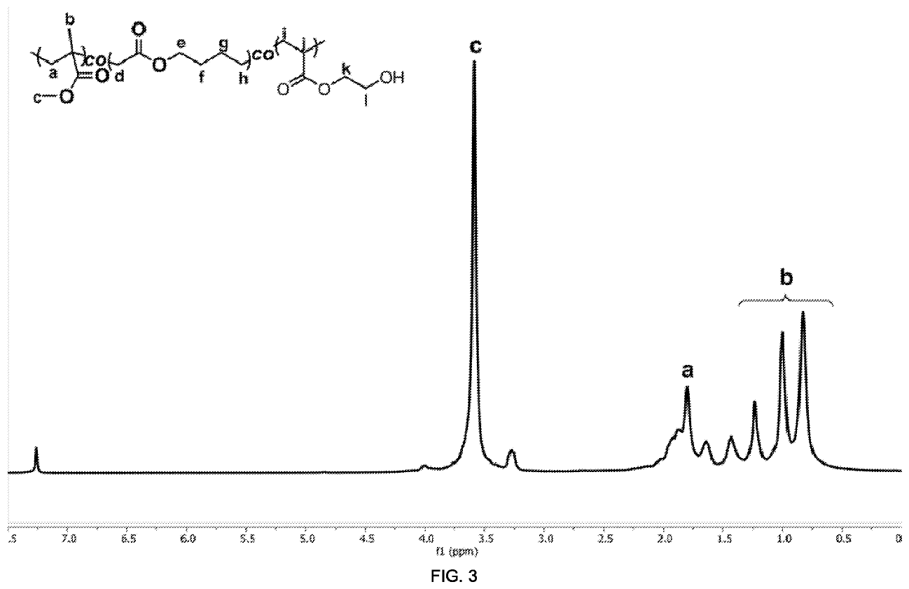

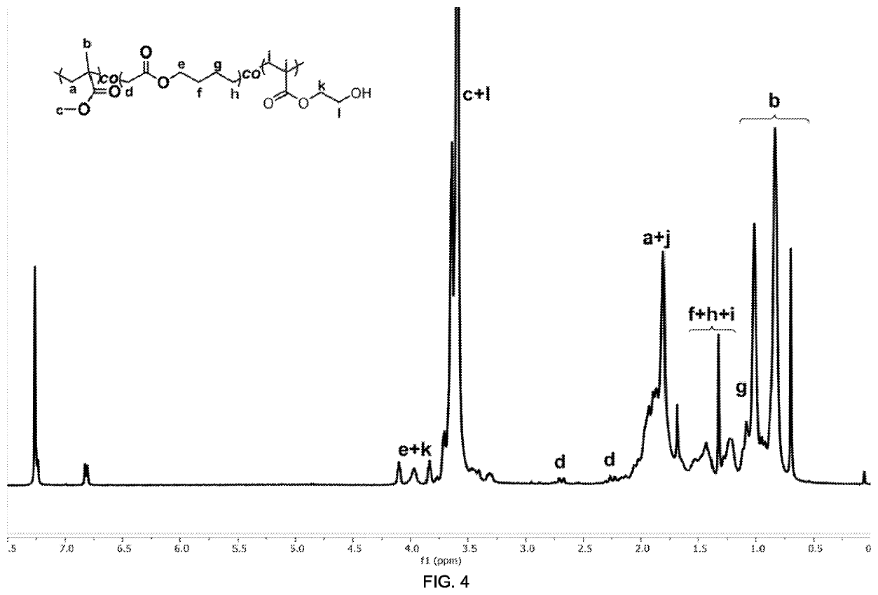

At the outset emulsion polymerization in water, with 1:4 ratio of MDO:MMA or 1:4:15 ratio of HEA:MDO:MMA, ammonium persulfate (APS) as radical source, TBAB as stabilizer, SDS as surfactant at higher pH (12) stirring at 70° C. for 4 h under argon, produced only PMMA and MDO hydrolyzed product without observing any copolymer by ¹H NMR analysis (EM1-EM2). Replacing SDS with Triton X-100 and keeping other conditions unchanged, yielded/furnished poly(MDO-co-MMA-co-HEA) with 3% of MDO incorporation (EM3). ¹H NMR analysis for comparison between EM2 and EM3 to distinguish PMDO protons is shown in FIG. 3 and FIG. 4 respectively. Without being bound by theory, it is hypothesized that the neutral surfactant Triton X-100 and with the combination of hydrophobic and hydrophilic nature of HEA at high pH plays a crucial role in stabilizing monomers droplet towards completing polymerization. It was also noticed that the formation of side MDO hydrolyzed product is minimized at high pH than neutral and acidic pH conditions. In another experiment, a copolymer was yielded/furnished with a significant improvement in MDO incorporation (9%) where TBAB was not taken into account (EM4). To confirm the reproducibility of EM4 results, the reaction was repeated and not much difference was observed for the polymer composition (EM5). Switching from HEA to HEMA or from surfactant Triton X-100 to Poloxamer-188 or PEG-b-PCL did not significantly change polymer compositions (EM6-EM7 and EM9), except low solid content for PEG-b-PCL. A control experiment was also conducted to check the effect of HEA where <1% of MDO incorporation was detected in the absence of HEA (EM8). After polymerization, all polymeric emulsions were purified with DI water three times by centrifuging at 7830 rpm/45 min at room temperature prior to NMR analysis.

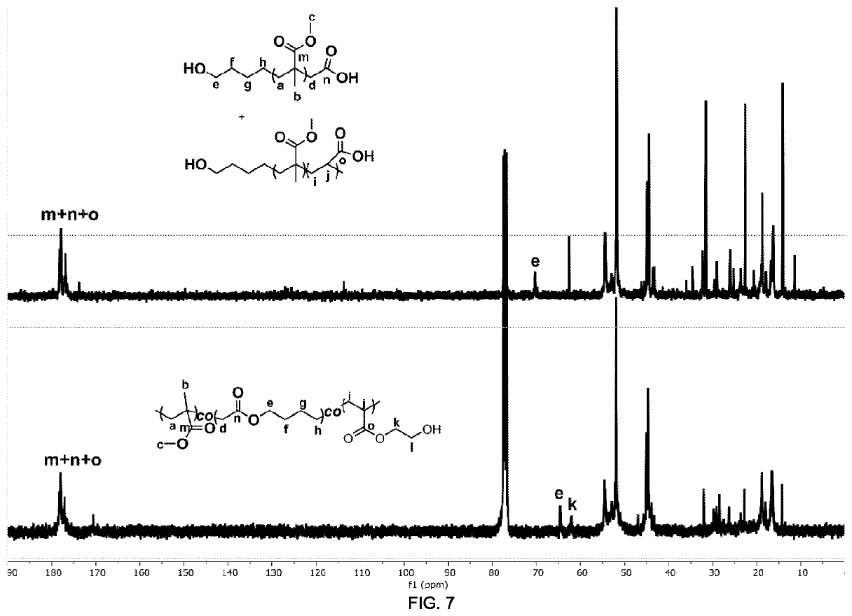

From ¹H NMR of poly(MDO-co-MMA-co-HEA) in FIG. 4, peak e at 3.97 ppm and peaks d between 2.7-2.2 ppm are methylene protons (—CH₂—C(O)O—CH₂—) regards to degradable units of polyester. The methylene protons adjacent to carbonyl (—CH₂C(O)O—) is often observed as a single peak in the homopolymerization of MDO but it was seen here as two different peaks at 2.7 ppm and 2.2 ppm. The splitting is due to differences in configuration and the shift supports a copolymer with a random distribution. The higher shifted peak at 2.7 ppm corresponds to a proton d (FIG. 4) where MDO directly connected to acrylate and the lower shifted peak at 2.2 ppm corresponds to the same proton d where MDO monomers are connected within it. Peaks e and d are used to estimate the amount of couplings, i.e. the mol % of MDO monomer coupled to acrylate monomer with the comparison of proton c (methyl ester of MMA). Peaks 178.2, 177.9 and 177.1 ppm from ¹³C NMR (FIG. 7) correspond to carboxylate of PMMA, MDO and HEA respectively and which are also used to estimate the amount of monomers couplings.

### Example 3: Polymer Degradability

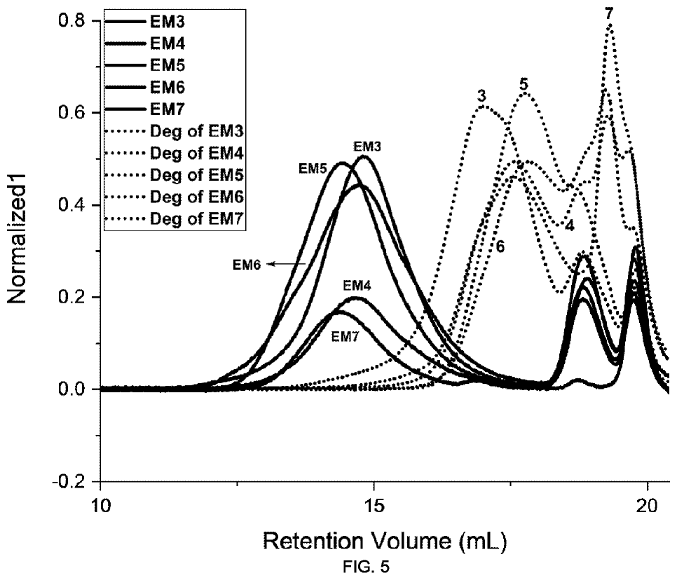

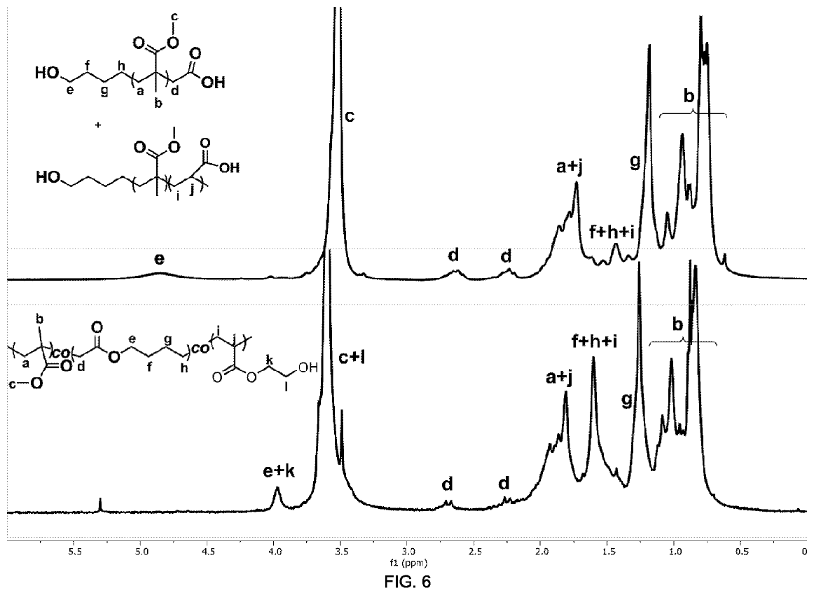

To demonstrate degradability, poly(MDO-co-MMA-co-HEA) (EM3-EM7) was treated with an excess of KOH in 1:3 mixture of methanol and tetrahydrofuran solvent combination at room temperature for 72 h, affording short-chain methacrylate-based oligomers (Table 3, FIG. 5, Table 4, FIG. 6 and FIG. 7). The copolymers were degraded by the cleavage of ester bonds in polymeric backbone, as revealed by a decrease in molar mass during hydrolysis. GPC analysis (Table 3, FIG. 5 and Table 4, EM3-EM7) was performed before and after hydrolytic degradation of copolymer. It was observed that copolymers with higher molar mass ranging 48,531-109,896, was degraded to the range 1,071-4,619 based on their degradable units in polymer backbone. These values correlate nicely with the degree of main-chain ester incorporation of 0.03-0.09 mol % calculated by ¹H NMR. PDI values were recorded as 2.63-6.97 for purified polymers and 1.55-3.65 for oligomers.

The observation was made in degradation reactions from the supporting data of ¹H, ¹³C NMR (FIG. 6 and FIG. 7) and GPC analysis (Table 3, FIG. 5 and Table 4) where shifting of the peak e from 3.9 ppm to 4.8 ppm in ¹H NMR and very small shift of carbonyl of carboxylate peaks from 178.2, 177.9 and 177.1 ppm to 178.1, 177.8, and 176.9 ppm for MMA, MDO and HEA respectively and also shifting of the peak e corresponds to methylene protons (—C(O)O—CH₂—) of MDO from 64.6 ppm to 70.3 ppm in ¹³C NMR were clear indication of its polymeric backbone degradation. However, peaks d were slightly shifted because of their newly formed neighbouring group carboxylic acid. The GPC results also supported the hydrolytic degradation where very significant degradation shifts were observed (FIG. 5).

TABLE 3
Characterization of emulsion polymerization and hydrolytic degradation
for poly(MDO-co-MMA-co-HEA) copolymers (EM3-EM7)

| | Conversion | | | | Polymer Characterization | | | | Degradation Characterization | | | |
|---|---|---|---|---|---|---|---|---|---|---|---|---|
| | of | mol % | Polymer | | (by GPC) | | | | (by GPC) | | | |
| | MMA/MDO | MDO- | composition^{b} | | | | | PDI | | | | PDI |
| Experiment | (%)^{a} | Polymer^{b} | MMA | MDO | Mₙ | M_{w} | Mₚ | (M_{w}/Mₙ) | Mₙ | M_{w} | Mₚ | (M_{w}/Mₙ) |
| EM3 | 99/99 | 3 | 0.97 | 0.03 | 49,520 | 283,513 | 121,551 | 5.72 | 4,619 | 16,891 | 6,601 | 3.65 |
| EM4 | 99/99 | 9 | 0.90 | 0.09 | 48,531 | 233,392 | 150,103 | 4.80 | 3,088 | 5,180 | 3,238 | 1.67 |
| EM5 | 99/99 | 7 | 0.93 | 0.07 | 69,688 | 312,727 | 204,831 | 4.48 | 1,071 | 2,763 | 2,568 | 2.57 |
| EM6 | 99/99 | 7 | 0.93 | 0.07 | 46,739 | 325,896 | 135,838 | 6.97 | 2,402 | 3,735 | 2,421 | 1.55 |
| EM7 | 99/99 | 6 | 0.92 | 0.08 | 109,896 | 288,974 | 222,552 | 2.63 | 2,546 | 5,968 | 3,331 | 2.34 |

ªDetermined by ¹H NMR analysis of crude polymeric emulsion.
ªDetermined by ¹H NMR analysis of purified sample.

TABLE 4
Number average molecular weight (Mₙ) distribution
of polymer before and after degradation

| | Polymer | Degradation |
|---|---|---|
| Sample ID | Mₙ | Mₙ |
| EM3 | 49,520 | 4,619 |
| EM4 | 48,531 | 3,088 |
| EMS | 69,688 | 1,071 |
| EM6 | 46,739 | 2,402 |
| EM7 | 109,896 | 2,546 |

### Example 4: Polymer Characterization

Next, poly(MDO-co-MMA-co-HEA) nanoparticles were characterized by various instruments like Dynamic Light Scattering (DLS), Scanning Electron Microscope (SEM) and Transmission Electron Microscope (TEM).

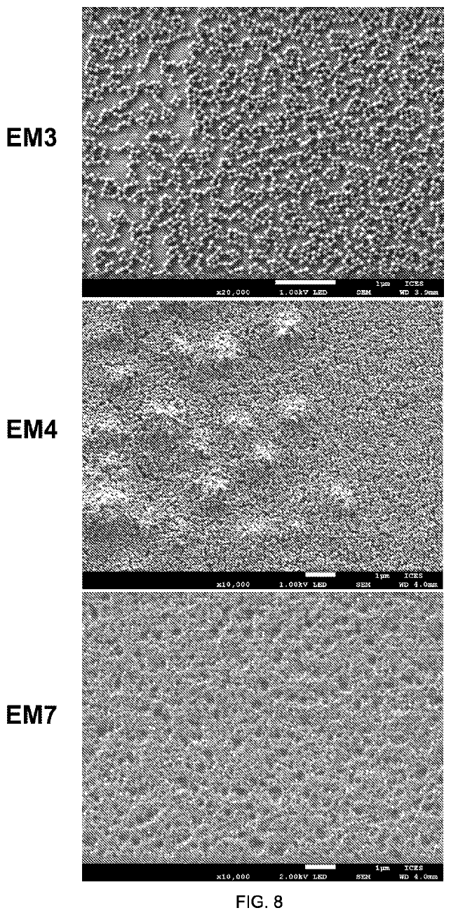

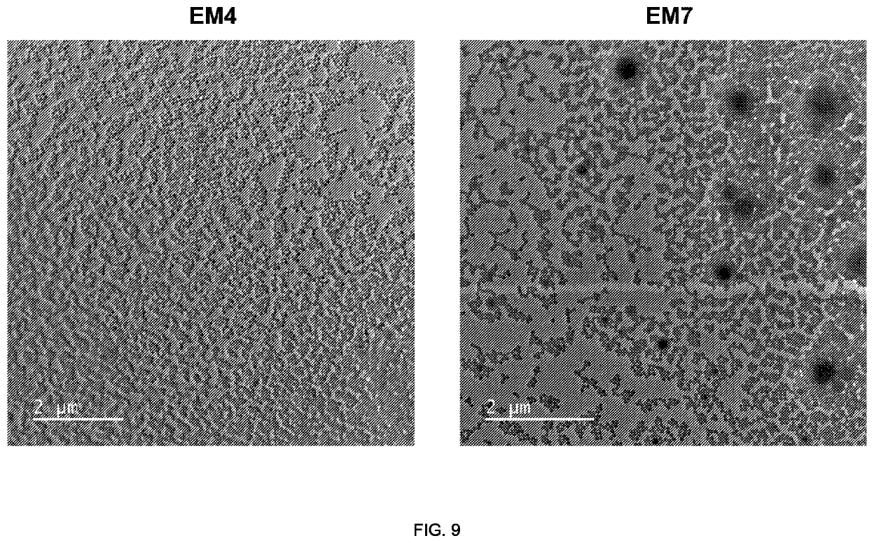

Table 5 shows particles size in Z-average and number mean with PDI from SEM and TEM analysis. The corresponding SEM images obtained for EM3, EM4 and EM7 are shown in FIG. 8, while the corresponding TEM images obtained for EM4 and EM7 are shown in FIG. 9. Dispersions of EM3, EM4 and EM7 showed particle size of 237 nm, 194 nm and 266 nm by Z-average and 218 nm, 146 nm and 183 nm by number mean respectively with narrow size distribution. All three of the dispersions were shown to be spherical in size with smooth surface by SEM and TEM analysis. EM3, EM4 and EM7 displayed good long term-stability of the nanoparticles of more than 3 months whereas other polymeric dispersion EM9 showed instability within days.

TABLE 5
DLS, SEM and TEM analysis of poly(MDO-
co-MMA-co-HEA) nanoparticles

| | Z-average | Number | |
|---|---|---|---|
| Experiment | (nm) | mean (nm) | PDI |
| EM3 | 237.9 ± 1.59 | 218.0 ± 2.13 | 0.055 ± 0.006 |
| EM4 | 194.9 ± 2.06 | 146.7 ± 5.01 | 0.175 ± 0.01 |
| EM7 | 266.6 ± 2.19 | 183.5 ± 15.55 | 0.276 ± 0.01 |

### Example 5: Investigation on Different Types of Surfactants

To investigate the behaviour of other neutral surfactants, experiments were carried out in order to identify mol % of MDO incorporation in main-chain methacrylate polymer (Table 6). All polymerization conditions were remained unchanged from the conditions of EM4 except that surfactant is switched. Reactions with Ryota sugar ester, Span 80, Tween 80 and Tween 20 provided copolymers with 3-4% of MDO incorporation (EM10-EM11 and EM14-EM15) whereas with Triton X-405 and Span 85 gave only PMMA homopolymer (EM12-EM13). Copolymers EM10-EM11 and EM14-EM15 showed instability of the nanoparticles after completing the reaction. EM4 reaction conditions were also screened by switching Triton X-100 surfactant with other ionic surfactants, but surprisingly none of the experiment yielded poly(MDO-co-MMA-co-HEA) where either formation of mixture of PMMA and hydrolyzed MDO or only PMMA was observed by ¹H NMR analysis (EM16-EM18 and EM20, Table 7). Attempting one of the reactions with other initiator V-50 was also not successful (EM19, Table 7).

TABLE 6
Screening of other neutral surfactants to make poly(MDO-co-MDO-co-HEA) copolymers

| | | Conversion of | MDO | Polymer | | |
|---|---|---|---|---|---|---|
| | | MMA/MDO | incorporation | composition | | MDO-hydrolysis |
| Experiment | Surfactant | (%) | (%) | MMA | MDO | (%) |
| EM10 | Ryoto sugar ester | 99/99 | 4 | 0.96 | 0.04 | 3 |
| EM11 | Span 80 | 99/99 | 3 | 0.97 | 0.03 | 0 |
| EM12 | Triton X-405 | 99/99 | not detected | 1.0 | 0 | 0 |
| EM13 | Span 85 | 99/99 | not detected | 1.0 | 0 | 0 |
| EM14 | Tween 80 | 99/99 | 3 | 0.97 | 0.03 | 2 |
| EM15 | Tween 20 | 99/99 | 3 | 0.96 | 0.04 | 5 |

TABLE 7
Screening of ionic surfactants to check the feasibility to make poly(MDO-co-MDO-co-HEA) copolymers

| | | | Conversion of | MDO | | |
|---|---|---|---|---|---|---|
| | | | MMA/MDO | incorporation | PMMA | MDO- |
| Experiment | Initiator | Surfactant | (%) | (%) | (%) | hydrol |
| EM16 | APS | Dihexyl sulfosuccinate | 99/99 | not detected | 3 | 17 |
| | | sodium | | | | |
| EM17 | APS | Sodium | 89/99 | not detected | 87 | 13 |
| | | dodecylbenzene | | | | |
| | | sulfonate (SDBS) | | | | |
| EM18 | APS | Cetyltrimethyl | 99/99 | not detected | 97 | 3 |
| | | ammonium bromide | | | | |
| | | (CTAB) | | | | |
| EM19 | V-50 | Cetyltrimethyl | 99/99 | not detected | 67 | 33 |
| | | ammonium bromide | | | | |
| | | (CTAB) | | | | |
| EM20 | APS | Benzethonium | 99/99 | not detected | >99 | not detected |
| | | chloride (hyamine) | | | | |

### Example 6: Summary

In summary, degradable version of acrylate latex was successfully synthesized via radical ring-opening emulsion copolymerization of 2-methylene-1,3-dioxepane (MDO) with methyl methacrylate (MMA) and 2-hydroxyethyl acrylate (HEA) in water. The novel technology enables scalable production for variety of biodegradable poly acrylates in which the use of water is of high interest due to their low viscosity and non-toxic “green” solvent. It has been demonstrated that surfactant and pH of reaction medium play crucial role in incorporating cleavable ester bridges in main-chain polymer backbone and also stabilizing monomers droplet towards completing polymerization with long term-stability of nanoparticles. The proportion of MDO derived ester groups in the polymer was obtained up to 9% which is optimal for biodegradability, such polymers are highly desired for biomedical and cosmetic applications. The copolymers poly(MDO-co-MMA-co-HEA) and its oligomeric degraded products were well characterized by ¹H, ¹³C NMR and GPC analysis. The scalability and applicability of this technology is very evident from the simplicity of the procedure and benign nature of the reaction medium.

Without being bound by theory, it is believed that, mechanistically, once free radical HEA-MMA co-oligomers are formed in continuous phase, they enter in the micelle in a fast phase transfer, and once entered in the micelle, these chains are stabilized by neutral surfactant. This could be minimizing or eliminating MMA side chain hydrolysis. The present technology uses a high pH and a neutral surfactant as the main component for the successful emulsion polymerization of MMA like monomers with MDO. The incorporation of MDO into MMA latex is uniform as evidenced by the degradation experiments despite the reactivity difference between the two monomers. The conditions used in the present method not only reduces the hydrolysis of the MDO monomer, but also ensures uniform incorporation of ester units in the emulsion polymer backbone. In addition, one key observation made includes the observation of an initial faint tint blue scattering which showed formation of seed particles in the first 15 minutes of the polymerization.

### Example 7: Emulsion Polymerizations Using Various Acrylates, Vinyl

Acetate and Acrylic Acid Monomers, and Polymer Degradability Besides using methyl methacrylate (MMA) as a main bulk monomer for acrylate emulsions, experiments were also conducted using other acrylate monomers (e.g., n-butyl acrylate, ethyl acrylate, methyl acrylate, methyl methacrylate/butyl acrylate mixture, butyl methacrylate/butyl acrylate mixture, butyl arylate/2-(dimethylamino)ethyl methacrylate, 2-ethylhexyl acrylate), acrylic acid and vinyl acetate. The results are summarized in Table 8. All polymerization conditions were remained unchanged from the conditions of original EM4 as described in Table 2 except for switching monomer types, compositions and pH. 4VAc1MDO resulted in mixture of MDO hydrolyzed and poly(VAc) by-products at pH either 7 or 9, whereas 4AA1MDO produced only MDO hydrolyzed by-product.

Comparing the range of acrylates used, it was observed that the more hydrophobic acrylates monomers mix were able to obtain higher MDO % incorporation into their polymer backbone. This was observed from 3BA1MDO vs. 3MA1MDO where the former has 9 mol % MDO versus 5 mol % MDO incorporation. However, when the monomer mixtures are too hydrophobic, aggregates were formed as the latexes were unable to stabilize in the aqueous medium as seen in 3EHA1MDO. From 1MMA3BA20MDO and 1MMA3BA10MDO samples, the sample with lower MDO composition in the monomer mix did not detect MDO incorporation in the polymer latex via NMR analysis, which suggests a significant amount of MDO was hydrolyzed before the remaining could be polymerized into the polymer backbone and only very little MDO is incorporated. Interestingly, for the 3BMA1MDO, 3BA1MDO5DMAEMA and 1BA2BMA1MDO monomer compositions, a higher MDO incorporation of 14 mol %, 33 mol % and 40 mol % was observed respectively. In conclusion, the compositions with linear and higher hydrophobic monomers (BA and BMA) provided higher mol % of MDO incorporation in their corresponding polymer backbone.

TABLE 8
Screening of emulsion polymerizations using various acrylates, vinyl acetate and acrylic acid monomers

| | | | | | | MDO |
|---|---|---|---|---|---|---|
| | | | | | | incorporation |
| | Monomer composition | | | Z-average | | (mol %) in |
| Sample | (wt %) | Initiator | Conditions | (d · nm) | PDI | polymer latex |
| 4Vac1MDOª | 75% VAc, 20% MDO, 5% HEA | APS | Triton X-100 (0.125 g) | — | — | n.d. |
| 4Vac1MDO^{b} | 75% VAc, 20% MDO, 5% HEA | APS | H₂O (12 g) | — | — | n.d. |
| 4AA1MDO | 80% AA, 20% MDO | APS | aq. NaOH (4 g) | — | — | n.d. |
| 3BA1MDO | 71% BA, 24% MDO, 5% HEA, | APS | pH 8.5-10.5 | 300.9 | 0.256 | 9 |
| | 0.2% EGDMA | | 70° C. | | | |
| 3EA1MDO | 71% EA, 24% MDO, 5% HEA, | APS | 4 h | 347.5 | 0.086 | 9 |
| | 0.2% EGDMA | | | | | |
| 3MA1MDO | 71% MA, 24% MDO, 5% HEA, | APS | | 713.1 | 0.138 | 5 |
| | 0.2% EGDMA | | | | | |
| 1MMA3BA20MDO | 19% MMA, 56% BA, 20% MDO, | APS | | 275.6 | 0.028 | 10 |
| | 5% HEA, 0.2% AMA | | | | | |
| 1MMA3BA10MDO | 21% MMA, 64% BA, 10% MDO, | APS | | 227.5 | 0.060 | n.d. |
| | 5% HEA, 0.2% AMA | | | | | |
| 3BA1MDO | 71% BA, 24% MDO, 5% DMAEMA, | APS | | 273.9 | 0.092 | 33 |
| 5DMAEMA | 0.2% EGDMA | | | | | |
| 3BMA1MDO | 71% BMA, 24% MDO, 5% HEA, | APS | | 244.3 | 0.040 | 14 |
| | 0.2% EGDMA | | | | | |
| 1BA2BMA1MDO | 24% BA, 47% BMA, 24% MDO, | APS | | 228.2 | 0.073 | 40 |
| | 5% HEA, 0.2% EGDMA | | | | | |
| 3EHA1MDO | 71% EHA, 24% MDO, 5% HEA, | APS | | aggregate | — | — |
| | 0.2% EGDMA | | | | | |

^{a}Final reaction pH is 9.
^{b}Final reaction pH is 7.
VAc = Vinyl acetate.
AA = Acrylic acid.
BA = n-butyl acrylate.
EA = Ethyl acrylate.
MA = Methyl acrylate.
MMA = Methyl methacrylate.
DMAEMA = 2-(Dimethylamino)ethyl methacrylate.
BMA = n-Butyl methacrylate.
EHA = 2-Ethylhexyl acrylate.
AMA = Allyl methacrylate.
EGDMA = Ethylene glycol dimethacrylate.
n.d. = not detected.

To demonstrate degradability of the polymer, the polymers were treated with an excess of KOH in 1:3 mixture of methanol and tetrahydrofuran solvent combination at room temperature for 72 h, affording short-chain methacrylate or acrylate-based oligomers.

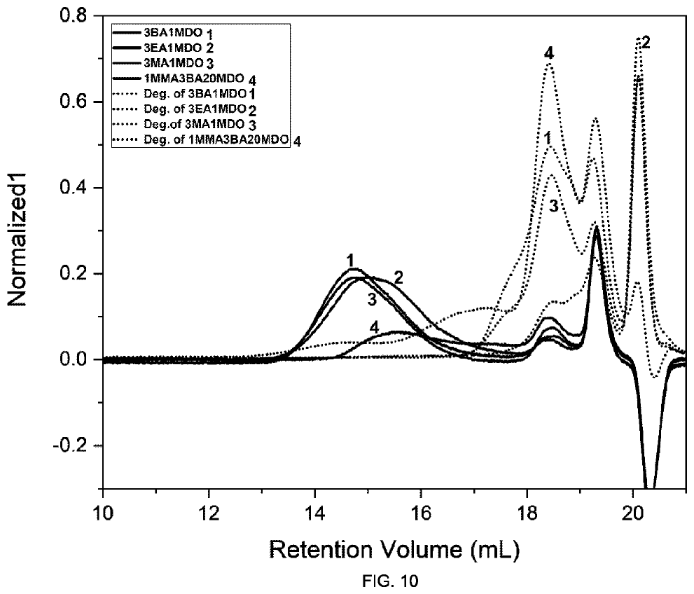

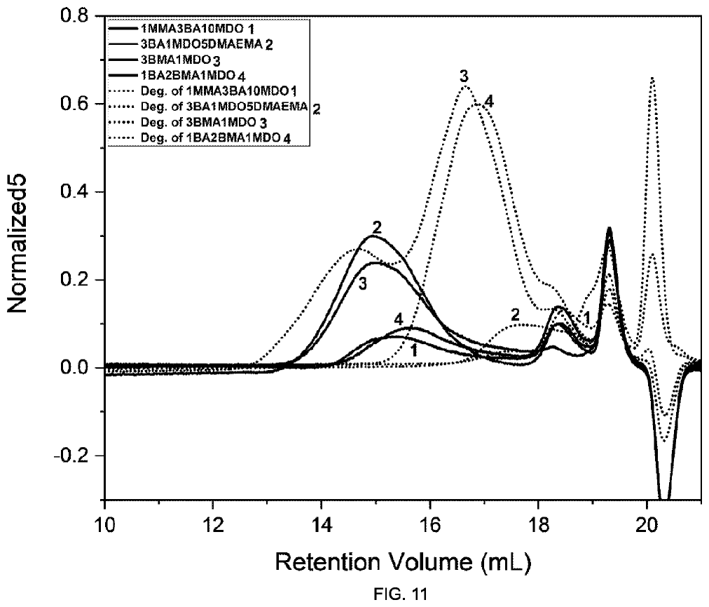

The copolymers were degraded by the cleavage of ester bonds in the polymeric backbone, as revealed by a decrease in molar mass during hydrolysis as observed from GPC analysis (FIG. 10, FIG. 11 and Table 9).

Additional results summarized above show the potential of the technology in developing degradable emulsions with various methacrylic esters.

TABLE 9
Molecular weight distribution before and after hydrolytic degradation from GPC Data

| | Before Degradation | | | | After Degradation | | | |
|---|---|---|---|---|---|---|---|---|
| | Mₙ | M_{w} | Mₚ | PDI | Mₙ | M_{w} | Mₚ | PDI |
| Sample | [Da] | [Da] | [Da] | (M_{w}/Mₙ) | [Da] | [Da] | [Da] | (M_{w}/Mₙ) |
| 3BA1MDO | 32,900 | 105,200 | 95,000 | 3.12 | 700 | 1,000 | 700 | 1.36 |
| 3EA1MDO | 21,100 | 83,100 | 65,800 | 3.92 | 800 | 950 | 650 | 1.18 |
| 3MA1MDO | 45,800 | 108,500 | 91,600 | 2.36 | 700 | 970 | 700 | 1.39 |
| 1MMA3BA20MDO | 8,300 | 27,700 | 33,900 | 3.31 | 400 | 580 | 700 | 1.41 |
| 1MMA3BA10MDO | 14,500 | 42,000 | 43,200 | 2.9 | 600 | 700 | 670 | 1.11 |
| 3BA1MDOSDMAEMA | 26,800 | 90,200 | 71,500 | 3.36 | 280 | 310 | 270 | 1.1 |
| 38MA1MDO | 17,700 | 73,200 | 69,600 | 4.13 | 3,400 | 9,000 | 6,900 | 2.64 |
| 1BA2BMA1MDO | 11,380 | 32,000 | 27,800 | 2.81 | 2,600 | 6,500 | 5,180 | 2.47 |

### Example 8: Experimental Methods

### 8.1. Materials and Reagents

All chemicals were purchased from Sigma Aldrich and used as received, unless stated otherwise. 2-Methylene-1,3-dioxepane (MDO), PCL (polycaprolactone) and PEG-b-PCL (poly(ethylene glycol)-b-polycaprolactone) were synthesized as previously published in Bailey, W. J. et al., Polym. Sci. Pol. Chem. 1982, 20, 3021-3030 and Ang, P. et al., ACS Sustainable Chem. Eng. 2021, 9, 2, 669-683, the contents of which are fully incorporated herein by reference. 5M NaOH was prepared and stored as a stock solution. Methyl methacrylate (MMA), 2-hydroxyethyl acrylate (HEA) and 2-hydroxyethyl methacrylate (HEMA) were passed through basic Al₂O₃ before polymerization to remove inhibitors. CDCl₃ was passed through anhydrous Na₂CO₃ to remove any traces of internally formed hydrochloric acid which may cause hydrolysis of polyester and unreacted MDO to avoid difficulty in analysis. Spectra was recorded on a 400 MHz Bruker Ultrashield Avance 400SB Spectrometer equipped with a BPO probe and variable temperatures capabilities, operating at a Larmor frequency of 400.23 MHz for ¹H and 100.65 MHz for ¹³C using chloroform-d (CDCl₃) as solvent and tetramethylsilane (TMS, 5=0) as internal reference at 21° C. One-dimensional ¹H NMR spectra was acquired with 64746 data points, 64 scans, 29.9585 ppm spectral width (11990.407 Hz), 1 s delay, 2.70 s acquisition time and a 25° flip angle. One-dimensional ¹³C NMR spectra were recorded with 65536 data points, 4000 to 15700 scans, 238.2643 ppm spectral width (23980.814 Hz), 10 s relaxation delay, 1.37 s acquisition time and a 90° flip angle with inverse-gated decoupling. Gel permeation chromatography (GPC) was conducted on a Viscotek TDAmax which consists of three components—the GPCmax integrated solvent and sample delivery module, the TDA 302 Triple Detector Array, and the OmniSEC software. The TDA 302 incorporates RI and, Light Scattering detectors and viscometer. Only RI detector was used. 2 columns: 2×PLgel 10 um Mixed-B (500 to 10,000,000) were applied in sequence for separation. Tetrahydrofuran (THF) was used as the eluent at 1.0 mL/min with column and detector temperature at 40° C. Polystyrene standards were used for conventional calibration. Dynamic light scattering (DLS) was conducted on a Malvern Zetasizer Nanoseries at 25° C. Scanning electron microscopy (SEM) measurement was conducted by using JSM7900FLV. The latex dispersion was placed and dried on the silica substrate supported by carbon tape, examined at an acceleration voltage of 2-5 kV. Transmission electron micrographs (TEM) were obtained using a JEOL JEM-2200FS high-resolution transmission electron microscope at an accelerating voltage of 200 kV.

8.2. Synthetic Procedure of Poly(MMA-Co-MDO) Monomers MMA (1.0 g, 10.0 mmol) and MDO (1.14 g, 10.0 mmol) were transferred into a 25 mL Schlenk flask (rinsed with Et₃N and dried under high vacuum before monomers transfer) fitted with magnetic stir bar and pre-dried AIBN (33 mg, 0.2 mmol). Then anhydrous ethanol (10 mL, from Sigma) was injected into Schlenk flask and degassed by six cycles of freeze-pump-thaw for 2 hr. Reaction mixture was heated to 70° C. with stirring at 945 rpm for 24 hr. After this time, sampling was done to estimate the reaction conversion by ¹H NMR analysis. Later, the reaction mixture was cooled to room temperature and ethanol was decanted, added with 20 mL of ethanol and stirred at room temperature for 2 hr. The resulted polymer solid was filtered through Buckner funnel and dried under high vacuum to get white powder (1.0 g, 47% yield, 9% MDO incorporation=P(MMA(0.91)-co-MDO(0.09)).

### 8.3. Preparation of Cross-Linked Poly(MDO-Co-MMA) (Mini E-3 and Mini E-4)

Poly(MDO-co-MMA) and PCL were used as co-stabilizers for the reaction of Mini E-3 and Mini E-4 respectively. MDO (2.5 g), MMA (2.5 g), EGDMA (ethylene glycol dimethacrylate) (0.1 g) and poly(MDO-co-MMA) (0.1 g) or PCL (0.1 g) were mixed in 50 mL plastic tube and cooled with ice-water bath. Initiator, V-65 (2,2′-azobis(2.4-dimethyl valeronitrile)) (0.1 g) was added to the oil mixture. SDS (sodium dodecyl sulfate) (0.1 g), NaHCO₃ (0.1 g) was added to water (20 g) in another 50 mL plastic tube, the mixture was cooled in ice-water bath. The oil mixture was added to the aqueous mixture, and the resulting mixture was well-shaken in the 50 mL plastic tube and ultra-sonicated at 30 W for 30 sec. The emulsion mixture was then transferred to a 50 mL round-bottom flask and was heated at 50° C. with stirring at 400 rpm for 18 hr. The emulsion was then centrifuged and washed with DI water for 3 times in a 50 mL centrifuge tube.

### 8.4. Preparation of Poly(MDO-Co-MMA-Co-HEA) Nanoparticles (EM3, EM4, EM6 and EM7)

To a stirred solution of Triton X-100 (0.125 g) or Poloxamer-188 (0.125 g; for EM7 only), TBAB (tetra-n-butylammonium bromide) (0.2 g; for EM3 only) in DI water (12.0 g) in 50 mL single-neck RBF was added 5M NaOH (4.0 g) dropwise under argon gas for 2 min. The resulted solution was purged with argon gas for 30 min at 70° C. with 705 rpm. APS (ammonium persulfate) (0.3 g) was dissolved in 0.4 mL of DI water and was added dropwise to the reaction mixture and purged with argon gas for another 5 min. Then the monomer mixture (MMA, MDO and HEA or HEMA) was prepared, added to the reaction mixture in one portion and purged with argon gas for another 1 min. The resulted emulsion was monitored to maintain pH 10-12 with the addition of 5M NaOH dropwise (observed that reaction pH drops very fast so to maintain pH 10-12, 5M NaOH was added in frequent intervals. Total ˜3.0 g of 5M NaOH consumed throughout the reaction). The reaction was stirred at 70° C. for 4 h. After this time, sampling was done to estimate the reaction conversion by ¹H NMR analysis. Later, the reaction was quenched by rapid cooling and purified with DI water by three consequent centrifugations at 7830 rpm/45 min. The resulted solid was dried in vacuum oven at 40° C. for 16 h to get white solid. NMR data for SMOT05-8: solid content 5 wt %; ¹H NMR (400 MHz, CDCl₃-d), δ (TMS, ppm): 3.97 (bs, 2H(—C(O)O—CH₂—CH₂—CH₂—CH₂—, MDO)+2H(—C(O)O—CH₂—CH₂—OH), 3.68-3.52 (m, 3H(—C(O)O—CH₃—, MMA)+2H(—C(O)O—CH₂—CH₂—OH, HEA), 2.71-2.67 (m, 2H, —CH₂—C(O)O—, MDO), 2.27-2.23 (m, 2H, —CH₂—C(O)O—, MDO), 1.93-1.81 (m, 2H(—CH₂—, MMA)+1H (—CH₂—, HEA), 1.68-1.43 (m, 2H (—C(O)O—CH₂—CH₂—CH₂—CH₂—, MDO)+2H (—C(O)O—CH₂—CH₂—CH₂—CH₂—, MDO)+2H (—CH₂—CH—, HEA), 1.32-1.20 (m, 2H, (—C(O)O—CH₂—CH₂—CH₂—CH₂—, MDO), 1.12-0.84 (m, 3H, —CH₃, MMA). ¹³C NMR (400 MHz, CDCl₃-d), δ (TMS, ppm): 178.2 (—C(O)O—CH₃, MMA), 177.9 (—C(O)O—, MDO), 177.1 (—C(O)O—, HEA), 64.6 (—C(O)O—CH₂—, MDO), 62.0 (—C(O)O—CH₂—, HEA), 54.5, 52.8, 51.9, 45.0, 44.6, 43.8, 32.0, 29.8, 29.3, 29.1, 28.5, 26.2, 22.8, 18.8, 18.0, 16.5, 14.2.

8.5. Preparation of Poly(MDO-Co-MMA-Co-HEA) Nanoparticles with Lower pH

To a stirred solution of Triton X-100 (0.125 g; EM25) or Ryoto Sugar Ester (0.125 g; EM26), in DI water (12.0 g) in 50 mL single-neck RBF was added 5M NaOH (2.0 g) dropwise under argon gas for 2 min. The resulted solution was purged with argon gas for 30 min at 70° C. with 705 rpm. APS (ammonium persulfate) (0.3 g) dissolved in 0.4 mL of DI water and was added dropwise to the reaction mixture and purged with argon gas for another 5 min. Then monomer mixture (MMA, MDO and HEA) was prepared, added to the reaction mixture in one portion and purged with argon gas for another 1 min. The resulted emulsion was monitored to maintain pH 8.5 to 10.5 with the addition of 5M NaOH dropwise (observed that reaction pH drops very fast so to maintain pH 8.5 to 10.5, 5M NaOH was added in frequent intervals. Total ˜2.0 g of 5M NaOH consumed throughout the reaction). The reaction was stirred at 70° C. for 4 h. After this time, sampling was done to estimate the reaction conversion by ¹H NMR analysis. Later, the reaction was quenched by rapid cooling and purified with DI water by three consequent centrifugations at 7830 rpm/45 min. The resulted solid was dried in vacuum oven at 40° C. for 16 h to get white solid.

### 8.6. Degradation of Poly(MDO-Co-MMA-Co-HEA) (EM5)

To a stirred solution of P(MDO-co-MMA) (200 mg) in THF (12 mL) was added a solution of KOH (400 mg) in MeOH (4 mL) at room temperature. The reaction mixture was stirred at room temperature for 48 h. Reaction mixture was acidified to pH 4-5 with 6M HCl at 0° C. Solvents were evaporated under reduced pressure and the obtained solids dried under high vacuum for 2 h to remove traces of solvents. CHCl₃ (10 ml) was added to the mixture of solids and stirred at room temperature for 2 h. Resulted undissolved salts were removed by syringe filtration and CHCl₃ was removed under reduced pressure to yield pale yellow viscous degraded polymer products (200 mg, crude). ¹H NMR (400 MHz, CDCl₃-d), δ (TMS, ppm): 4.86 (bs, 2H, —HO—CH—CH₂—CH₂—CH₂—, MDO), 3.57-3.51 (m, 3H, —C(O)O—CH₃—, MMA), 2.72-2.57 (m, 2H, —CH—C(O)OH, MDO), 2.28-2.19 (m, 2H, —CH₂—C(O)OH, MDO), 1.95-1.73 (m, 2H (—CH₂—, MMA)+1H (—OH, HEA), 1.55-1.33 (m, 2H (HO—CH₂—CH₂—CH₂—CH₂—, MDO)+2H (HO—CH₂—CH₂—CH₂—CH₂—, MDO)+2H (—CH₂—CH—, HEA), 1.25-1.13 (m, 2H, (HO—CH₂—CH₂—CH—CH₂—, MDO), 1.07-0.74 (m, 3H, —CH₃, MMA). ¹³C NMR (400 MHz, CDCl₃-d), δ (TMS, ppm): 178.1 (—C(O)O—CH₃, MMA), 177.8 (—C(O)OH, MDO), 176.9 (—C(O)OH, HEA), 70.3 (HO—CH—, MDO), 62.5, 54.4, 52.9, 52.0, 51.9, 51.7, 44.9, 44.8, 44.5, 43.5, 43.2, 34.6, 32.3, 31.7, 31.5, 29.0, 26.0, 25.2, 23.6, 22.6, 22.5, 20.6, 18.7, 17.9, 16.7, 16.3, 14.0, 11.4.

8.7. Preparation of 4Vac1MDO^{a}, 4Vac1MDO^{b}, 4AA1MDO, 3BA1MDO, 3EA1MDO, 3MA1MDO, 1MMA3BA20MDO, 1MMA3BA10MDO, 3BA1MDO 5DMAEMA, 3BMA1MDO, 1BA2BMA1MDO and 3EHA1MDO

To a stirred solution of Triton X-100 (0.125 g) in DI water (12.0 g) in 50 mL single-neck RBF was added 5M NaOH (2.0 g) dropwise under argon gas for 2 min. The resulted solution was purged with argon gas for 30 min at 70° C. with 705 rpm. APS (ammonium persulfate) (0.3 g) was dissolved in 0.4 mL of DI water and was added dropwise to the reaction mixture and purged with argon gas for another 5 min. Then monomer mixture (5.0 g) (composition, see Table 8) was prepared, added to the reaction mixture in one portion and purged with argon gas for another 1 min. The resulted emulsion was monitored to maintain pH 8.5 to 10.5 with the addition of 5M NaOH dropwise (observed that reaction pH drops very fast so to maintain pH 8.5 to 10.5, 5M NaOH was added in frequent intervals. Total ˜2.0 g of 5M NaOH consumed throughout the reaction). The reaction was stirred at 70° C. for 4 h. After this time, sampling was done to estimate the reaction conversion by ¹H NMR analysis. Later, the reaction was quenched by rapid cooling and purified with DI water by three consequent centrifugations at 7830 rpm/45 min. The emulsion was adjusted to 5% w/w with D.I. water.

It will be appreciated by a person skilled in the art that other variations and/or modifications may be made to the embodiments disclosed herein without departing from the spirit or scope of the disclosure as broadly described. For example, in the description herein, features of different exemplary embodiments may be mixed, combined, interchanged, incorporated, adopted, modified, included etc. or the like across different exemplary embodiments. The present embodiments are, therefore, to be considered in all respects to be illustrative and not restrictive.

1. A method for preparing a polymer having ester functionality in the backbone of the polymer, the method comprising a step of reacting a mixture of monomers that comprises:
(i) at least one first acrylate and/or methacrylate monomer;
(ii) at least one cyclic ketene acetal monomer; and
(iii) at least one additional monomer selected from the group consisting of a second acrylate and/or methacrylate monomer that is functionalized with hydrophilic groups, a vinylic monomer that is functionalized with hydrophilic groups, and combinations thereof in aqueous media to obtain the polymer.

2. The method of claim 1, wherein the reacting step is carried out in the presence of:
(a) initiator;
(b) surfactant;
(c) base; and
(d) optionally stabilizer.

3. The method of claim 2, wherein the reacting step comprises maintaining the pH of the mixture at an alkaline/basic pH through a controlled addition of the base at intervals.

4. The method of claim 3, wherein the pH of the mixture is maintained at a pH that falls in the range of from 8.0 to 12.5.

5. The method of claim 1, wherein the at least one first acrylate and/or methacrylate monomer is represented by general formula (1): 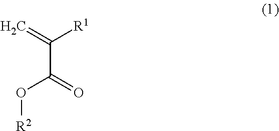
wherein
R¹ is selected from H or CH₃; and
R² is selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof.

6. The method of claim 5, wherein the at least one first acrylate and/or methacrylate monomer is selected from the group consisting of methyl acrylate, ethyl acrylate, n-propyl acrylate, isopropyl acrylate, n-butyl acrylate, t-butyl acrylate, isobutyl acrylate, pentyl acrylate, hexyl acrylate, n-amyl acrylate, isoamyl acrylate, heptyl acrylate, octyl acrylate, isooctyl acrylate, ethylhexyl acrylate, 2-ethylhexyl acrylate, vinyl acrylate, cycloalkyl acrylates, methyl methacrylate, ethyl methacrylate, n-propyl methacrylate, isopropyl methacrylate, n-butyl methacrylate, t-butyl methacrylate, isobutyl methaacrylate, pentyl methacrylate, hexyl methacrylate, n-amyl methacrylate, isoamyl methacrylate, heptyl methacrylate, octyl methacrylate, isooctyl methacrylate, ethylhexyl methacrylate, 2-ethylhexyl methacrylate, vinyl methacrylate, cycloalkyl methacrylates and combinations thereof.

7. The method of claim 1, wherein the at least one cyclic ketene acetal monomer is represented by general formula (2): 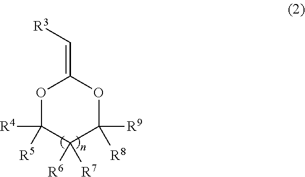
wherein
n is 0, 1, 2 or 3;
R³ is selected from H or optionally substituted linear or branched C₁-C₂₀ alkyl; and
R⁴ to R⁹ are each independently selected from H, optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof.

8. The method of claim 7, wherein the at least one cyclic ketene acetal monomer is selected from the group consisting of 2-methylene-1,3-dioxepane (MDO), 2-methylene-1,3-dioxocane and combinations thereof.

9. The method claim 1, wherein the second acrylate and/or methacrylate monomer that is functionalized with hydrophilic groups is represented by general formula (3): 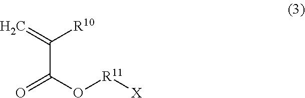
wherein
R¹⁰ is selected from H or CH₃;
R¹¹ is selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof, and X comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof.

10. The method of claim 9, wherein the second acrylate and/or methacrylate monomer is selected from the group consisting of 2-hydroxyethyl acrylate (HEA), hydroxyethyl methacrylate (HEMA), 2-(dimethylamino)ethyl acrylate (DMAEA), 2-(dimethylamino)ethyl methacrylate (DMAEMA) and combinations thereof.

11. The method of claim 1, wherein the vinylic monomer that is functionalized with hydrophilic groups is selected from the group consisting of vinyl pyrrolidone, sodium 1-allyloxy-2-hydroxypropyl sulfonate and combinations thereof.

12. The method of claim 1, wherein the at least one first acrylate and/or methacrylate monomer; the at least one cyclic ketene acetal monomer; and the at least one additional monomer are mixed in a mass ratio of 10-20:2-6:0.01-2.

13. The method of claim 1, wherein the reacting step is carried out in the presence of a crosslinking agent at a concentration falling in the range of from 0.1 wt % to 5.0 wt % with respect to the total weight of the monomers.

14. The method of claim 2,
wherein the initiator comprises water-soluble compound/salt optionally selected from persulfate salts, azo compounds or mixtures thereof;
wherein the surfactant comprises non-ionic surfactant optionally having one or more fatty acid ester chain and/or one or more poly(ethylene glycol)/polyoxyethylene chain; and/or
wherein the base comprises an inorganic base optionally selected from sodium hydroxide (NaOH), potassium hydroxide (KOH), sodium carbonate (Na₂CO₃), potassium carbonate (K₂CO₃), sodium bicarbonate (NaHCO₃), potassium bicarbonate (KHCO₃), ammonium hydroxide (NH₄OH) or mixtures thereof.

15.-16. (canceled)

17. The method of claim 1, wherein the reacting step comprises incorporating at least 3 mol % of the at least one cyclic ketene acetal monomer in the polymer.

18. The method of claim 1, wherein the reacting step is carried out at temperature of no more than 100° C.

19. A polymer having ester functionality in the backbone of the polymer, the polymer comprising one or more repeating/structural units represented general formula (4), one or more repeating/structural units represented by general formula (5) and one or more repeating/structural units represented by general formula (6) and/or general formula (8): 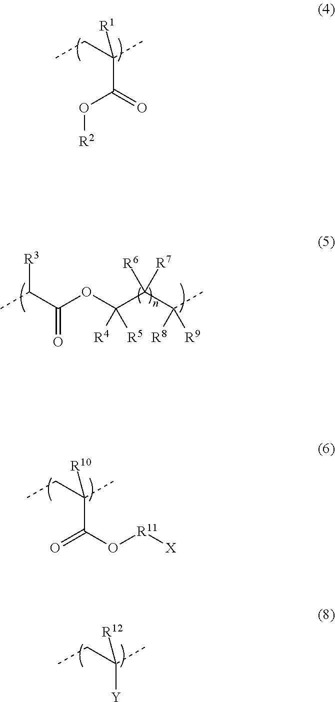
wherein
R¹ and R¹⁰ are each independently selected from H or CH₃;
R² and R¹¹ are each independently selected from optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof,
n is 0, 1, 2 or 3;
R³ is selected from H or optionally substituted linear or branched C₁-C₂₀ alkyl;
R⁴ to R⁹ and R¹² are each independently selected from H, optionally substituted linear or branched C₁-C₂₀ alkyl, optionally substituted linear or branched C₁-C₂₀ alkoxy, optionally substituted linear or branched C₂-C₂₀ alkenyl, optionally substituted linear or branched C₂-C₂₀ alkynyl, optionally substituted C₃-C₂₀ cycloalkyl, optionally substituted C₃-C₂₀ cycloalkenyl, optionally substituted C₆-C₂₀ aryl, optionally substituted C₃-C₂₀ heterocycloalkyl, optionally substituted C₃-C₂₀ heterocycloalkenyl, optionally substituted C₆-C₂₀ heteroaryl or combinations thereof; and
X and Y each comprises a hydrophilic moiety selected from hydroxy, carbonyl, carboxyl, carboxylate, amino, amine, amide, cyclic amide, sulfhydryl, sulfate, sulfonate, phosphate, carbonate, thiocarbonyl, thiocarboxyl, sulfinic, hydrazine, hydroxylamine or combinations thereof.

20. The polymer of claim 19, wherein the polymer is in the form of latex nanoparticles.

21. The polymer of claim 19, wherein the ratio of the total number of repeating/structural units represented by general formula (4), general formula (6) and/or general formula (8) to the total number of repeating/structural units represented by general formula (5) in the polymer is from 0.40 to 0.99:0.01 to 0.60.

22. The polymer of claim 19, wherein the polymer comprises at least 3 mol % of repeating units represented by general formula (5).
